(19) United States
(12) Patent Application Publication
(10) Pub. No.: US 2010/0063201 A1
(43) Pub. Date: Mar. 11, 2010

(54) METHOD FOR MANUFACTURING PIGMENT DISPERSION, AND AQUEOUS INK FOR INKJET RECORDING AND METHOD FOR MANUFACTURING THE SAME

(75) Inventor: Hiroshi YAMAMOTO, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/548,468

(22) Filed: Aug. 27, 2009

(30) Foreign Application Priority Data
Sep. 10, 2008 (JP) 2008-232548

(51) Int. Cl. C08L 31/02

(52) U.S. Cl. 524/558

(57) ABSTRACT

A method for manufacturing a pigment dispersion is provided. The method includes mixing a water-insoluble resin, carbon black, a neutralizing agent, an organic solvent, an anionic low-molecular weight surfactant and an aqueous medium to form an aqueous dispersion; and removing at least a part of the organic solvent from the aqueous dispersion. Further, a method for manufacturing an aqueous ink for inkjet recording and an aqueous ink for inkjet recording are provided.

### CROSS-REFERENCE TO RELATED APPLICATION

This application claims priority under 35 USC 119 from Japanese Patent Application No. 2008-232548 filed on Sep. 10, 2008, the disclosure of which is incorporated by reference herein.

### BACKGROUND OF THE INVENTION

1. Field of the Invention

The present invention is related to a method for manufacturing a pigment dispersion, an aqueous ink for inkjet recording and a method for manufacturing an aqueous ink for inkjet recording.

2. Description of the Related Art

With respect to a recording medium for inkjet recording and ink used therefor, various technologies are being studied in order to obtain a high quality recorded material excellent in color optical density, ink fixing property, resolution and the like.

As a colorant used in ink for inkjet recording, pigments are widely used from the view point of resistance to light, resistance to water and the like. In addition, in a recording liquid for an inkjet printer, carbon black is generally used as a pigment for black ink.

When carbon black is used as a pigment for black ink, high definition and advanced coloring rendering properties cannot be obtained unless carbon black has a small particle size and are stably dispersed. In particular, with respect to a recording liquid for an inkjet printer, the presence of pigment particles that are insufficiently dispersed is directly related to the problem of clogging of a nozzle in a discharge head. However, since carbon black has a fine primary particle diameter and a strong tendency for secondary aggregation, innovation is required to achieve a fine dispersion and also stably maintain particle diameter.

Under such circumstances, as a carbon black pigment which can be used for aqueous ink for inkjet recording, an aqueous dispersion for inkjet recording including a carbon black pigment coated with a water-insoluble polymer has been proposed (for example, see Japanese Patent Application Laid-Open (JP-A) No. 2007-169506). According to this document, such a dispersion is excellent in image density, image uniformity and the like.

### SUMMARY OF THE INVENTION

However, not only is the aqueous dispersion for inkjet recording described in JP-A No. 2007-169506 sometimes not satisfactory in terms of the density of the black color, but in some instances, for example in a case in which finer particles are desired, it is difficult to stably maintain the dispersed particle diameter after the fine dispersion is formed.

In recent years, for black ink, ink with a higher than conventional print density is required. However, currently it is difficult to ensure discharge stability while stably dispersing carbon black having a large specific surface area, i.e., small particle diameter, and such problems are not successfully resolved by conventional technology alone.

In addition, when an image is recorded, sometimes poor discharge directivity is caused due to adhesion and drying of an aggregate near a head due to occurrence of mist during discharge of liquid droplets. Since such an aggregate is not easily removed by newly discharged liquid, and the removability of the adhered aggregate (i.e., the maintainability) is insufficient, problems whereby malfunctions such as white spots are generated in a recorded image exist.

The present invention has been made in view of the above circumstances, and provides a method for manufacturing a pigment dispersion, a method for manufacturing an aqueous ink for inkjet recording and an aqueous ink for inkjet recording.

According to a first aspect of the invention, a method for manufacturing a pigment dispersion is provided. The method includes mixing a water-insoluble resin, carbon black, a neutralizing agent, an organic solvent, an anionic low-molecular weight surfactant and an aqueous medium to form an aqueous dispersion; and removing at least a part of the organic solvent from the aqueous dispersion.

According to a second aspect of the invention, a method for manufacturing an aqueous ink for inkjet recording is provided. The method includes mixing a water-insoluble resin, carbon black, a neutralizing agent, an organic solvent, an anionic low-molecular weight surfactant and an aqueous medium to form an aqueous dispersion; removing at least a part of the organic solvent from the aqueous dispersion to form a pigment dispersion; and preparing an aqueous ink for inkjet recording using the pigment dispersion.

According to a third aspect of the invention, an aqueous ink for inkjet recording, which is manufactured by the method for manufacturing a pigment dispersion of the first aspect is provided.

### DETAILED DESCRIPTION OF THE INVENTION

Method for Manufacturing Pigment Dispersion

The method for manufacturing a pigment dispersion includes a step of mixing at least one water-insoluble resin, at least one carbon black, at least one neutralizing agent, at least one organic solvent, at least one anionic low-molecular weight surfactant, and an aqueous medium to form an aqueous dispersion; and a step of removing at least a part of the organic solvent from the aqueous dispersion.

In the pigment dispersion of the invention, a carbon black coated with a water-insoluble resin is dispersed in an aqueous medium. In the method for manufacturing a pigment dispersion of the invention, by using an anionic low-molecular surfactant as a dispersion auxiliary, it is possible to efficiently manufacture a pigment dispersion that has favorable dispersion stability and especially has excellent filtering property. Further, by removing at least a part of a solvent from the aqueous dispersion, the dispersion stability may become further favorable.

In the step of mixing at least one water-insoluble resin, at least one carbon black, at least one neutralizing agent, at least one organic solvent, at least one anionic low-molecular weight surfactant, and an aqueous medium to form an aqueous dispersion, an anionic low-molecular weight surfactant having a high adsorption rate is used in the aqueous phase. Therefore, it can be considered that a pigment excellent in dispersion stability (particularly filtering property) can be obtained, as a result of, for example, reduction in dispersion time or suppression of over-dispersion due to improvement in dispersion rate, and suppression of the aggregation of fine particles generated by surface pulverization of carbon black with frictional force.

<Anionic Low-Molecular Weight Surfactant>

The anionic low-molecular weight surfactant in the invention may have a number-average molecular weight of 100 or more to less than 2000. The number-average molecular weight is preferably 200 to 1000, and more preferably 200 to 600, from the viewpoint of dispersibility.

The anionic low-molecular weight surfactant in the invention has a structure containing a hydrophilic group and a hydrophobic group. The anionic low-molecular weight surfactant may contain, in one molecule, one or more hydrophilic groups and one or more hydrophobic groups. The anionic low-molecular weight surfactant may have plural kinds of hydrophilic groups and/or plural kinds of hydrophobic groups. The anionic low-molecular weight surfactant may also have a linking group for linking a hydrophilic group to a hydrophobic group, if necessary.

The anionic low-molecular weight surfactant contains at least one anionic group as the hydrophilic group. The anionic group is not particularly limited as long as it has a negative charge. In the invention, the anionic group is preferably a phosphate group, a phosphonate group, a phosphinate group, a sulfate group, a sulfonate group, a sulfinate group or a carboxyl group, more preferably a phosphate group or a carboxyl group, still more preferably a carboxyl group.

Such an anionic group may form a salt structure. The salt may be either a salt with an organic cation or a salt with an inorganic cation.

As the hydrophilic group, the anionic low molecular weight surfactant may include a nonionic group in addition to the anionic group. Examples of the nonionic group include a part of polyethylene oxide, polyglycerin, sugar unit, or the like.

The hydrophobic group may have any structure of a hydrocarbon, fluorocarbon, silicone or the like. The hydrophobic group is preferably a hydrocarbon based hydrophobic group, from the viewpoint of dispersion stability.

The hydrophobic group may have either a linear structure or a branched structure. The hydrophobic group may have a linear structure having a single chain or two or more chains, and the structure having two or more chains may have plural kinds of hydrophobic groups. The hydrophobic group is preferably a hydrocarbon group having 2 to 24 carbon atoms, more preferably a hydrocarbon group having 4 to 24 carbon atoms, and still more preferably a hydrocarbon group having 6 to 20 carbon atoms.

Examples of the anionic low-molecular weight surfactant in the invention include a surfactant selected from the group consisting of alkyl sulfonic acid salts, alkyl benzene sulfonate salts, alkyl naphthalene sulfonate salts, alkane or olefin sulfonate salts, alkyl sulfate salts, polyoxyethylene alkyl or alkylaryl ether sulfate salts, alkyl phosphate salts, alkyl diphenyl ether disulfonate salts, ether carboxylate salts, oleic acid salts, alkyl sulfosuccinate salts, acylmethyltaurine ester salts, α-sulfofatty acid esters, and fatty acid salts, as well as condensates of higher fatty acids with amino acids, and naphthenates.

The anionic low-molecular weight surfactant that is more preferably used in the invention is a surfactant selected from the group consisting of alkyl benzene sulfonates (among these, more preferably, those having a linear alkyl chain), alkane or olefin sulfonate salts (among these, more preferably, secondary alkane sulfonate salts, α-olefin sulfonate salts), alkyl sulfate salts, polyoxyethylene alkyl or alkylaryl ether sulfate salts, alkyl phosphate salts, ether carboxylates, oleic acid salt, alkyl sulfosuccinate salts, acylmethyltaurine ester salts, α-sulfofatty acid esters, and fatty acid salts, and still more preferably a surfactant selected from oleic acid salts, alkyl sulfosuccinate salts, and acylmethyltaurine ester salts.

When any of these specific anionic low-molecular weight surfactants is used in the aqueous ink for inkjet recording, the ink having more excellent in abrasion resistance and discharge stability may be obtained.

These surfactants may be used alone or in combination of two or more thereof.

The amount of the anionic low-molecular weight surfactant added in the invention is preferably from 0.01 to 10% by mass, and more preferably 0.1 to 1% by mass, relative to the carbon black. When the anionic low-molecular weight surfactant is contained in a proportion (anionic low-molecular weight surfactant/carbon black ratio) of 0.01 to 10% by mass, more excellent dispersion stability (particularly filtering property) may be enabled.

In the method for manufacturing a pigment dispersion in the invention, it is preferable from the viewpoint of dispersion stability that a surfactant having a number-average molecular weight of 200 to 1000, which is selected from alkyl benzene sulfonate salts (particularly those having a linear alkyl chain), alkane or olefin sulfonate salts (particularly secondary alkane sulfonates, α-olefin sulfonates), alkyl sulfate salts, polyoxyethylene alkyl or alkylaryl ether sulfate salts, alkyl phosphate salts, ether carboxylates, oleic acid salts, alkyl sulfosuccinate salts, acylmethyltaurine ester salts, α-sulfofatty acid esters, and fatty acid salts, is used in an amount of from 0.01 to 10% by mass based on the carbon black. It is more preferable that a surfactant having a number-average molecular weight of 200 to 600, which is selected from oleic acid salts, alkyl sulfosuccinate salts, and acylmethyltaurine ester salts, is used in an amount of 0.1 to 1% by mass based on the carbon black.

<Water-Insoluble Resin>

In the method for manufacturing a pigment dispersion according to the invention, at least one water-insoluble resin is used. The water-insoluble resin used in the invention is not particularly limited as long as it is a resin that can be dissolved in an organic solvent so that at least a part of carbon black can be coated and the coated carbon black can be dispersed in an aqueous medium. Examples of the water-insoluble resin include a nonionic polymer compound is copolymers of monomers having an ethylenically unsaturated group, an anionic polymer compound is copolymers of monomers having an ethylenically unsaturated group, a cationic polymer compound is copolymers of monomers having an ethylenically unsaturated group, and an amphoteric polymer compound which is copolymers of monomers having an ethylenically unsaturated group.

The water-insoluble resin in the invention is preferably a resin including a hydrophilic structural unit and a hydrophobic structural unit, from the viewpoint of its ability to be stably present in an aqueous medium, to reduce the adhesion or deposition of aggregates, and to remove adhered aggregates easily.

In the invention, the water-insoluble resin preferably contains, as the hydrophobic structural unit, at least one of structural unit represented by the following formula (I):

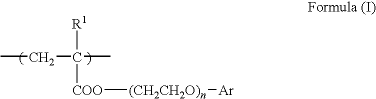

In formula (I), R¹ represents a hydrogen atom or a methyl group. R¹ is preferably a methyl group.

In formula (I), Ar represents an unsubstituted or a substituted aromatic ring. When the aromatic ring is substituted, examples of a substituent include, a halogen atom, an alkyl group, an alkoxy group, a hydroxy group, a cyano group and the like, and it may form a condensed ring. When a condensed ring is formed, examples thereof include a condensed aromatic ring having 8 or more carbon atoms, an aromatic ring in which a heterocycle is condensed, and two or more aromatic rings connected to each other.

The “condensed aromatic ring having 8 or more carbon atoms” may be an aromatic ring in which at least two or more benzene rings are condensed, or an aromatic compound having 8 or more carbon atoms including at least one aromatic ring and an alicyclic hydrocarbon condensed with the aromatic ring. Specific examples include naphthalene, anthracene, fluorene, phenanthrene, acenaphthene and the like.

The “aromatic ring in which a heterocycle is condensed” may be an aromatic ring wherein an aromatic compound which does not include any hetero atom (preferably a benzene ring) and a cyclic compound which includes a hetero atom is condensed with each other. Herein, the cyclic compound which includes a hetero atom is preferably 5- or 6-membered cyclic compound. As a hetero atom, a nitrogen atom, an oxygen atom or a sulfur atom is preferred. The cyclic compound which includes a hetero atom may include a plurality of hetero atoms. In this case, the hetero atoms may be the same or different from each other. Specific examples of an aromatic ring in which a heterocycle is condensed include phthalimide, acridone, carbazole, benzoxazole, benzothiazole and the like.

The aromatic ring represented by “Ar” is linked to the main chain of the water-insoluble resin via an ester group and an ethyleneoxide chain. Since the aromatic ring is not directly linked to the main chain, an appropriate distance is maintained between the hydrophobic aromatic ring and the hydrophilic structural unit. Therefore, an interaction between the water-insoluble resin and the pigment can easily occur, so that the resin is strongly adsorbed to the pigment, and the dispersibility can be improved.

Preferred examples of Ar include an unsubstituted benzene ring and an unsubstituted naphthalene ring. Particularly preferred is an unsubstituted benzene ring.

The symbol “n” represents an average repeating number of an ethyleneoxy chain that is contained in a water-insoluble resin. The symbol “n” is in the range of 1 to 6, preferably in the range of 1 to 2.

Specific examples of a monomer which forms a structural unit represented by the formula (I) include phenoxyethyl (meth)acrylate and the like, and the following monomers. The present invention is not limited to the following specific examples.

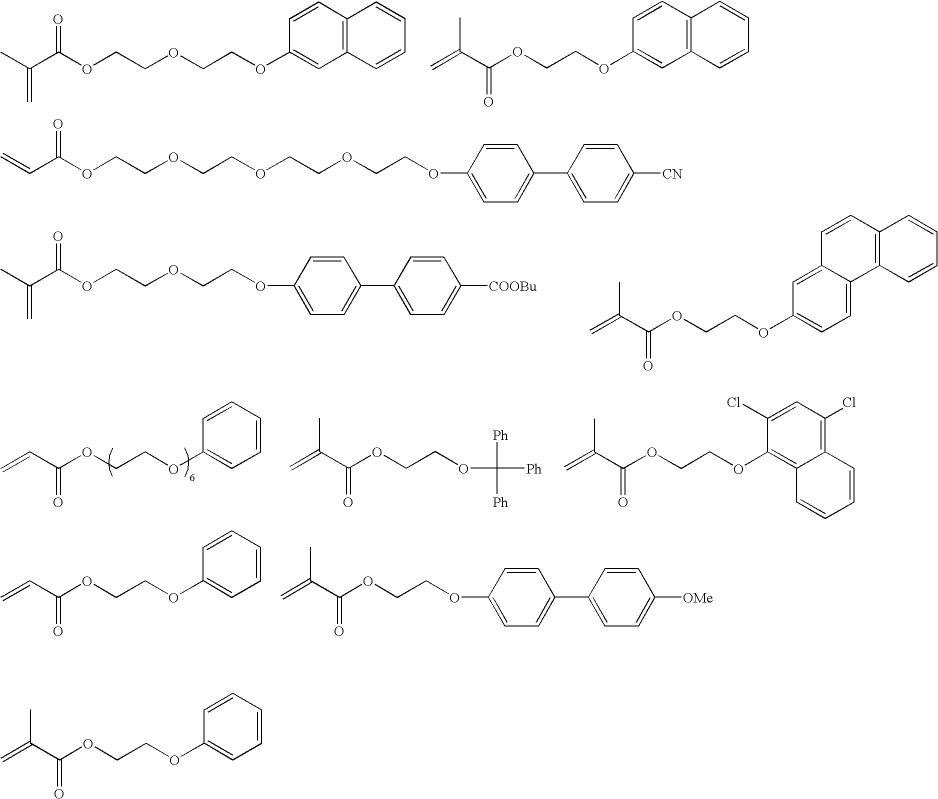

As the structural unit represented by the formula (I), in terms of dispersion stability, a structural unit in which R¹ is a methyl group, Ar is an unsubstituted benzene ring and n is in the range of 1 to 2 is particularly preferred.

The content of a structural unit represented by the formula (I) is preferably 30 to 70% by mass, and more preferably 40 to 50% by mass in the water-insoluble resin based on the total mass of the water-insoluble resin. When the content is 30% by mass or more, excellent dispersibility can be obtained. When it is 70% by mass or less, the adhesion and deposition of the aggregate can be inhibited, and the removability of the adhered aggregate (i.e., maintainability) is excellent, so that an image problem such as white spots can be prevented.

The water-insoluble resin of the invention may further include at least one hydrophobic structural unit (another hydrophobic structural unit), in addition to the structural unit represented by the formula (I).

Examples of another hydrophobic structural unit include a structural unit that does not belong to the hydrophilic structural unit (i.e., having no hydrophilic functional group) such as a structural unit derived from a vinyl monomer such as (meth)acrylates, (meth)acrylamides, styrenes, and vinyl esters, and a hydrophobic structural unit which has an aromatic ring linked to an atom included in a main chain via a linking group. These structural units can be used alone or in combination of two or more.

Examples of the (meth)acrylates include methyl(meth)acrylate, ethyl(meth)acrylate, butyl(meth)acrylate, isobutyl(meth)acrylate, hexyl(meth)acrylate and the like. Among these, methyl(meth)acrylate, ethyl(meth)acrylate and butyl(meth)acrylate are preferred. Methyl(meth)acrylate and ethyl(meth)acrylate are particularly preferred.

Examples of the (meth)acrylamides include (meth)acrylamides such as N-cyclohexyl(meth)acrylamide, N-(2-methoxyethyl)(meth)acrylamide, N,N-diallyl(meth)acrylamide, or N-allyl(meth)acrylamide.

Examples of the styrenes include styrene, methylstyrene, dimethylstyrene, trimethylstyrene, ethylstyrene, isopropylstyrene, n-butylstyrene, tert-butylstyrene, methoxystyrene, butoxystyrene, acetoxystyrene, chlorostyrene, dichlorostyrene, bromostyrene, chloromethylstyrene, hydroxystyrene which is protected by a group removable with an acidic compound (for example, t-Boc and the like), methyl vinylbenzoate, α-methylstyrene, vinyl naphthalene and the like. Among these, styrene and α-methylstyrene are preferred.

Examples of the vinyl esters include vinyl esters such as vinyl acetate, vinyl chloroacetate, vinyl propionate, vinyl butyrate, vinyl methoxyacetate or vinyl benzoate. Among these, vinyl acetate is preferred.

“(Meth)acrylate” means acrylate or methacrylate, “(meth)acrylamide” means acrylamide or methacrylamide, and “(meth)acrylic” means acrylic or methacrylic.

In the “hydrophobic structural unit which has an aromatic ring linked to an atom included in a main chain via a linking group”, the aromatic ring is linked to the atom included in the main chain of the water-insoluble resin via a linking group and thus not directly linked to the atom included in the main chain of the water-insoluble resin. As result, an appropriate distance is maintained between the hydrophobic aromatic ring and the hydrophilic structural unit, and therefore an interaction between the water-insoluble resin and the pigment can easily occur, and the resin is strongly adsorbed to the pigment, so that the dispersibility can be further improved.

The “hydrophobic structural unit which has an aromatic ring linked to an atom included in the main chain via a linking group” may be a structural unit represented by the formula (II) described below (in which the structural unit represented by the formula (I) is not included).

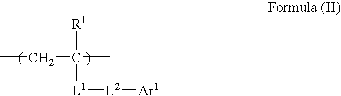

In formula (II), R¹ represents a hydrogen atom, a methyl group, or a halogen atom.

L¹ represents *—COO—, *—OCO—, *—CONR²—, *—O—, or a substituted or unsubstituted phenylene group, R² represents a hydrogen atom, or an alkyl group having 1 to 10 carbon atoms. The symbol “*” for L¹ represents a position linked to the main chain. When the phenylene group is substituted, examples of a substituent include a halogen atom, an alkyl group, an alkoxy group, a hydroxy group, a cyano group and the like, but not limited thereto.

L² represents a single bond or a divalent linking group having 1 to 30 carbon atoms, and when it is a divalent linking group, it is preferably a linking group having 1 to 25 carbon atoms, more preferably a linking group having 1 to 20 carbon atoms, and still more preferably a linking group having 1 to 15 carbon atoms.

Among these, particularly preferred are an alkyleneoxy group having 1 to 25 carbon atoms (more preferably 1 to 10 carbon atoms), an imino group (—NH—), a sulfamoyl group, and a divalent linking group which includes an alkylene group such as an alkylene group having 1 to 20 carbon atoms (more preferably 1 to 15 carbon atoms) or an ethylene oxide group [—(CH₂CH₂O)ₙ—, wherein n is 1 to 6], and a group in which two or more of these groups are combined.

In the formula (II), Ar¹ represents a monovalent group derived from an aromatic ring.

The aromatic ring represented by Ar¹ is not specifically limited. Examples of the aromatic ring represented by Ar¹ include a benzene ring, a condensed aromatic ring having 8 or more carbon atoms, an aromatic ring in which a heterocycle is condensed, and two or more benzene rings that are connected to each other. Detailed information regarding the condensed aromatic ring having 8 or more carbon atoms and the aromatic ring in which a heterocycle is condensed is the same as described above.

Herein below, specific examples of a monomer which can form the hydrophobic structural unit which has an aromatic ring linked to an atom included in a main chain via a linking group are given. However, according to the invention, it is not limited to the following specific examples.

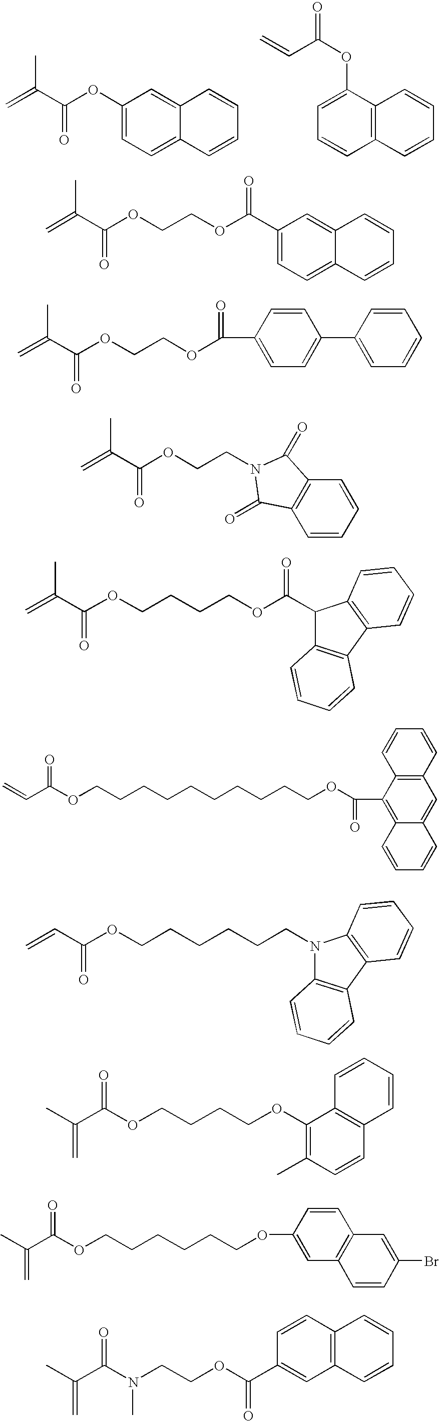

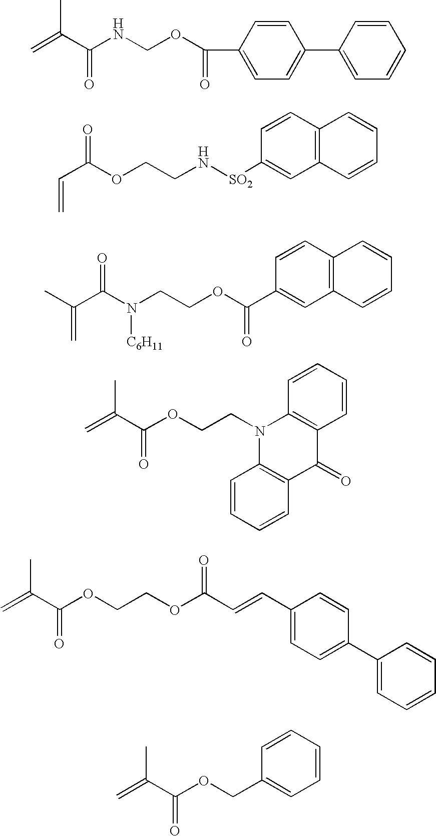

The hydrophilic structural unit in the water-insoluble resin which may be included in the water-soluble resin is not specifically limited as long as it is a structural unit derived from a monomer containing a hydrophilic group. The hydrophilic group may be any one of an anionic group, a cationic group or a non-ionic group. In the present invention, the water-insoluble resin preferably includes at least one structural unit containing an anionic hydrophilic group as a hydrophilic structural unit, from the viewpoint of dispersibility. The water-insoluble resin preferably includes a structural unit derived from at least one of acrylic acid or methacrylic acid as the hydrophilic structural unit.

In the present invention, the water-insoluble resin preferably includes a structural unit derived from at least one of acrylic acid or methacrylic acid, and the water-insoluble resin may includes another hydrophilic structural unit. Examples of another hydrophilic structural unit include a structural unit derived from a monomer containing a non-ionic hydrophilic group or a cationic hydrophilic group.

Examples of the non-ionic or cationic “hydrophilic functional group” include a hydroxy group, an amino group, an amide group (nitrogen atom is unsubstituted) and alkylene oxides such as polyethylene oxide or polypropylene oxide as described below.

Examples of the monomer containing a non-ionic or cationic hydrophilic group include a structural unit derived from a vinyl monomer such as a (meth)acrylate containing a non-ionic or cationic hydrophilic functional group, a (meth)acrylamide containing a non-ionic or cationic hydrophilic functional group and a vinyl ester containing a non-ionic or cationic hydrophilic functional group.

The monomer which forms a hydrophilic structural unit having a non-ionic or cationic hydrophilic group is not specifically limited as long as it includes a functional group such as an ethylenic unsaturated bond which can form a polymer and a non-ionic or cationic hydrophilic functional group, and it can be selected from known monomers. Specific examples thereof preferably include hydroxyethyl(meth)acrylate, hydroxybutyl(meth)acrylate, (meth)acrylamide, aminoethylacrylate, aminopropylacrylate, and (meth)acrylate which includes an alkylene oxide polymer.

The hydrophilic structural unit which includes a non-ionic or cationic hydrophilic group can be formed by polymerization of a corresponding monomer. Alternatively, hydrophilic functional groups may be introduced to the polymer chain after polymerization.

As a hydrophilic structural unit which includes a non-ionic hydrophilic group, a hydrophilic structural unit including an alkylene oxide structure is more preferred. As the alkylene moiety in an alkylene oxide structure, an alkylene moiety having 1 to 6 carbon atoms is preferred, an alkylene moiety having 2 to 6 carbon atoms is more preferred, and an alkylene moiety having 2 to 4 carbon atoms is even more preferred, in terms of hydrophilicity. In addition, the polymerization degree of the alkylene oxide structure is preferably 1 to 120, more preferably 1 to 60 and even more preferably 1 to 30.

In addition, as a hydrophilic structural unit which includes a non-ionic hydrophilic group, a hydrophilic structural unit including a hydroxy group is also preferred. With respect to the number of a hydroxy group included in a structural unit, in terms of hydrophilicity of the water-insoluble resin and compatibility with other monomers and solvent used during polymerization, it is preferably 1 to 4, more preferably 1 to 3, and even more preferably 1 to 2, but not specifically limited thereto.

When the water-insoluble resin includes the hydrophilic structural unit, the content of the hydrophilic structural unit in the water-insoluble resin of the invention may vary depending on the ratio of the hydrophobic structural unit. For example, when the water-insoluble resin consists of acrylic acid and/or methacrylic acid [hydrophilic structural unit] and the hydrophobic structural unit, the content of acrylic acid and/or methacrylic acid is calculated by “100—(% by mass of the hydrophobic structural unit)”.

A single type of the hydrophilic structural unit can be used, or a combination of two or more types thereof can be used.

In the water-insoluble resin of the invention, although the composition ratio of the hydrophilic structural unit and hydrophobic structural unit (including the structural unit represented by the formula (I)) varies depending on hydrophilicity and hydrophobicity of each units, it is preferred that the content of the hydrophilic structural unit is 15% by mass or less. In this case, the content of the hydrophobic structural unit is preferably more than 80% by mass, and more preferably 85% by mass or more with respect to the total mass of the water-insoluble resin.

When the hydrophilic structural unit is included in an amount of 15% by mass or less, the amount of the component that is dissolved by itself in an aqueous liquid medium can be reduced, and various properties including dispersibility of the pigment can be improved. As a result, when inkjet recording is carried out, a favorable ink discharge property can be obtained.

The content of the hydrophilic structural unit is preferably in the range of more than 0% by mass to 15% by mass, more preferably in the range of 2 to 15% by mass, still more preferably in the range of 5 to 15% by mass, and even still more preferably in the range of 8 to 12% by mass with respect to the total mass of the water-insoluble resin.

The content of aromatic rings included in the water-insoluble resin is preferably 27% by mass or less, more preferably 25% by mass or less, and still more preferably 20% by mass or less with respect to the total mass of the water-insoluble resin. Among these, the range of 15 to 20% by mass is preferred and the range of 17 to 20% by mass is more preferred. When the content of aromatic rings falls within the above range, resistance to scrubbing is improved.

The acid number of the water-insoluble resin of the invention is preferably 30 mg KOH/g or more but 100 mg KOH/g or less, in terms of dispersibility of the pigment and storage stability. More preferably, it is 30 mg KOH/g or more but 85 mg KOH/g or less. Even more preferably, it is 50 mg KOH/g or more but 85 mg KOH/g or less.

The acid number is defined as the mass (mg) of KOH that is required for complete neutralization of 1 g of the water-insoluble resin and is measured by the method according to JIS Standard (JIS K0070, 1992), the disclosure of which is incorporated by reference herein.

The weight average molecular weight (Mw) of the water-insoluble resin of the invention is preferably 30,000 or more, more preferably 30,000 to 150,000, still more preferably 30,000 to 100,000 and even still more preferably 30,000 to 80,000. In the case of the molecular weight of 30,000 or more, a steric repulsive effect for a dispersion agent tends to be improved, and due to such a steric effect, adsorption onto pigment can be improved.

In addition, the number average molecular weight (Mn) is preferably in the range of 1,000 to 100,000, and more preferably in the range of 3,000 to 50,000. When the number average molecular weight falls within the above range, function of the resin as a coating layer on the pigment or coating layer of an ink composition can be obtained. According to the invention, the water-insoluble resin is preferably used in a form of salt of an alkaline metal or an organic amine.

In addition, the molecular weight distribution of the water-insoluble resin of the invention (weight average molecular weight/number average molecular weight) is preferably in the range of 1 to 6, and more preferably in the range of 1 to 4. When the molecular weight distribution falls within the above range, dispersion stability and discharge stability of ink can be improved.

The number average molecular weight and weight average molecular weight are measured by gel permeation chromatography (GPC). As a GPC instrument, HLC-8020GPC (manufactured by Tosoh Corp.) is used, and three columns of TSKGEL, SUPER MULTIPORE HZ-H (manufactured by Tosoh Corp., 4.6 mmID×15 cm) were used. The detection was carried out using THF (tetrahydrofuran) as an eluent, and the molecular weight is calculated by a conversion with a polystyrene as a standard material. As a measurement condition, sample concentration is 0.35% by mass, flow rate is 0.35 ml/min, sample injection amount is 10 μl, and measurement temperature is 40° C., and an IR detector is used for detection. In addition, the calibration curve is established by using eight samples of “STANDARD SAMPLE TSK STANDARD, POLYSTYRENE” (manufactured by Tosoh Corp.): F-40, F-20, F-4, F-1, A-5000, A-2500, A-1000 and n-propylbenzene.

The water-insoluble resin of the invention can be polymerized according to various polymerization methods such as solution polymerization, precipitation polymerization, suspension polymerization, precipitation polymerization, bulk polymerization, or emulsion polymerization. The polymerization reaction can be carried out according to a known operational process such as a batch process, a semi-continuous process, a continuous process and the like. Examples of the method for initiating polymerization include a method using a radical initiator, a method using light or radiation and the like. These methods for polymerization and method for initiating polymerization are described in literatures; for example “Method for polymer synthesis” (revised edition, Tsuruta Teiji, 1971, Nikkan Kogyo Shimbun) or “Experimental method for polymer synthesis” (Otsu Takayuki and Kishita Masayoshi, 1972, Kagaku Dojin, pp 124-154).

Among the polymerization methods, a solution polymerization using a radical initiator is particularly preferred. Examples of a solvent which can be used for a solution polymerization include various organic solvents such as ethyl acetate, butyl acetate, acetone, methylethyl ketone, methylisobutyl ketone, cyclohexanone, tetrahydrofuran, dioxan, N,N-dimethylformamide, N,N-dimethylacetamide, benzene, toluene, acetonitrile, methylene chloride, chloroform, dichloroethane, methanol, ethanol, 1-propanol, 2-propanol, or 1-butanol. The solvent may be used alone or in combination of two or more. In addition, it can be used as a mixed solvent with water. It is necessary to set the temperature for polymerization considering molecular weight of a polymer to be produced, and types of an initiator and the like. In general, it is approximately 0° C. to 100° C. Preferably, the polymerization is carried out under the temperature range of 50° C. to 100° C. The reaction pressure can be appropriately selected and it is generally 1 kg/cm² to 100 kg/cm², and more preferred is 1 kg/cm² to 30 kg/cm². The reaction time may be approximately 5 hours to 30 hours. The resin produced may be further purified by re-precipitation and the like.

Herein below, specific examples of a preferred water-insoluble resin of the invention are described. However, it is not limited thereto in the invention. Meanwhile, the values described at the bottom right side of the parentheses for B-11-B-13 indicate mass percentage (% by mass).

| | | |
|---|---|---|
| 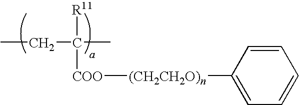 | 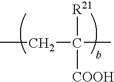 | 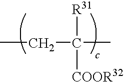 |

(a, b and c represent the respective composition ratios (% by mass))

| | R¹¹ | n | R²¹ | R³¹ | R³² | a | b | c | Mw |
|---|---|---|---|---|---|---|---|---|---|
| B-1 | CH₃ | 1 | CH₃ | CH₃ | CH₃ | 60 | 9 | 31 | 35500 |
| B-2 | H | 1 | H | H | CH₂CH₃ | 69 | 10 | 21 | 41200 |
| B-3 | CH₃ | 2 | CH₃ | CH₃ | CH₃ | 70 | 11 | 19 | 68000 |
| B-4 | CH₃ | 4 | CH₃ | CH₃ | CH(CH₃)CH₃ | 70 | 7 | 23 | 72000 |
| B-5 | H | 5 | H | H | CH₃ | 70 | 10 | 20 | 86000 |
| B-6 | H | 5 | H | H | CH₂CH(CH₃)CH₃ | 70 | 2 | 28 | 42000 |
| B-7 | CH₃ | 1 | CH₃ | CH₃ | CH₂CH₃ | 50 | 11 | 39 | 44500 |
| B-8 | CH₃ | 1 | CH₃ | CH₃ | CH₂CH₃ | 50 | 10 | 40 | 51200 |
| B-9 | H | 1 | H | H | CH₂CH₃ | 45 | 11 | 44 | 48900 |
| B-10 | H | 1 | CH₃ | CH₃ | CH₂CH₃ | 45 | 12 | 43 | 43600 |

| | | Mw |
|---|---|---|
| B-11 | 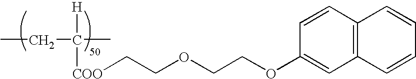 | 72400 |
| | 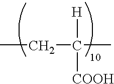 | |
| | 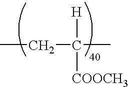 | |
| B-12 | 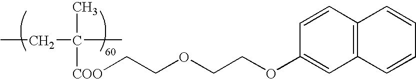 | 33800 |
| | 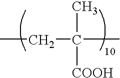 | |
| | 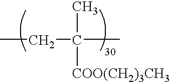 | |
| B-13 | 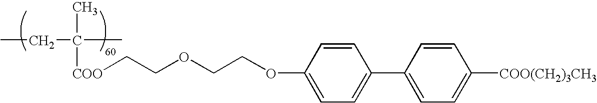 | 39200 |
| | 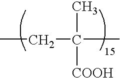 | |
| | 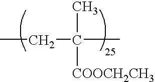 | |

<Carbon Black>

The carbon black used in the invention is not specifically limited. It is preferable to contain a carbon black having a relatively large particle surface area, that is, a specific surface area of 180 m²/g or more but less than 400 m²/g according to a BET method. The carbon black having a specific surface area in the above range has a relatively small particle diameter. When the pigment dispersion obtained by the manufacturing method of the invention is used in, for example, in an aqueous ink, a higher print density may be obtained. Further, when the carbon black is coated with the water-insoluble resin and included in an ink, favorable dispersibility and dispersion stability after a dispersion process can be obtained, so that a black colored ink having a stable ink discharge property can be obtained.

The specific surface area of carbon black is preferably in the range of 180 m²/g or more but less than 300 m²/g from the viewpoint of print density and ink-discharging property, and, more preferably in the range of 200 m²/g or more but 280 m²/g or less from the viewpoint of dispersibility.

The specific surface area in the invention indicates a specific surface area that is determined according to BET method. BET method is one type of a method for measuring surface area of powder by vapor phase adsorption. In this method, from an adsorption isotherm, a total surface area of one gram of a sample, i.e., a specific surface area, is measured. In general, nitrogen gas is mainly used as an absorption gas, and a method in which an adsorption amount is measured from the pressure or volume change of a gas that is being adsorbed is most commonly used. The most well-known formula for representing the isotherm of multimolecular adsorption was established by Brunauer, Emmett and Teller (so called, BET formula), and is widely used for determination of surface area. Based on BET formula, an adsorption amount is calculated, and then by multiplying it with surface area that is occupied by a single adsorption molecule, the surface area can be obtained.

Examples of carbon black include those produced by known methods such as a contact method, a furnace method, or a thermal method.

Specific examples of carbon black used in the invention include RAVEN7000, RAVEN5750, RAVEN5250, RAVEN5000 ULTRAII, RAVEN3500, RAVEN2000, RAVEN1500, RAVEN1250, RAVEN1200, RAVEN1190 ULTRAII, RAVEN1170, RAVEN1255, RAVEN1080, RAVEN1060, RAVEN700 (all manufactured by Colombian Carbon Corp.), REGAL400R, REGAL330R, REGAL660R, MOGUL L, BLACK PEARLS L, MONARCH700, MONARCH800, MONARCH880, MONARCH900, MONARCH1000, MONARCH1100, MONARCH1300, MONARCH1400 (all manufactured by Cabot Corp.), COLOR BLACK FW1, COLOR BLACK FW2, COLOR BLACK FW2V, COLOR BLACK 18, COLOR BLACK FW200, COLOR BLACK S150, COLOR BLACK S160, COLOR BLACK S170, PRINTEX 35, PRINTEX U, PRINTEX V, PRINTEX 140U, PRINTEX 140V, SPECIAL BLACK 6, SPECIAL BLACK 5, SPECIAL BLACK 4A, SPECIAL BLACK 4, NIPEX180-IQ, NIPEX170-IQ (all manufactured by Evonik Degussa Co., Ltd), and No.25, No.33, No.40, No.45, No.47, No.52, No.900, No.2200B, No.2300, No.990, No.980, No.970, No.960, No.950, No.850, MCF-88, MA600, MA7, MA8, MA100 (all manufactured by Mitsubishi Chemical Corp.) and the like, but not limited thereto.

Carbon black can be used alone in single type or in combination of two or more different types.

The mass ratio between the carbon black (cb) and the water-insoluble resin (r) according to the invention (i.e., cb:r) is preferably 100:25 to 100:140. More preferably, it is 100:25 to 100:50. When the ratio (cb:r) is 100:25 or more, dispersion stability and resistance to scrubbing tend to be improved. When the ratio is 100:140 or less, dispersion stability tends to be improved.

<Neutralizing Agent>

The neutralizing agent is used to neutralize a part of or the whole dissociating group and to form a stabily emulsified or a stably dispersed state in which the water-insoluble resin is stably dispersed in water.

Examples of the neutralizing agent include alcohol amines (for example, diethanol amine, triethanol amine, 2-amino-2-ethyl-1,3-propane diol and the like), hydroxides of an alkali metal (for example, lithium hydroxide, sodium hydroxide, potassium hydroxide and the like), ammonium hydroxides (for example, ammonium hydroxide and quaternary ammonium hydroxide), phosphonium hydroxides, alkali metal carbonates and the like. Among these, sodium hydroxide and potassium hydroxide are preferably used.

<Organic Solvent>

Preferable examples of the organic solvent used in the invention include alcohol solvents, ketone solvents and ether solvents. Examples of the alcohol solvent include isopropyl alcohol, n-butanol, t-butanol, and ethanol. Examples of the ketone solvent include acetone, methylethyl ketone, diethyl ketone, and methylisobutyl ketone. Examples of the ether solvent include dibutyl ether, and dioxane. Among these solvents, a ketone solvent such as methylethyl ketone and an alcohol solvent such as isopropyl alcohol are preferred. Methylethyl ketone is more preferred.

The method for manufacturing a pigment dispersion of the invention includes a step of mixing a water-insoluble resin, a carbon black, a neutralizing agent, an organic solvent, an anionic low-molecular weight surfactant and an aqueous medium to form an aqueous dispersion, and a step of removing at least a part of the organic solvent from the aqueous dispersion. The method may further include additional step(s), as necessary.

The method for manufacturing a pigment dispersion of the invention is basically a method called as a phase inversion emulsification method. The phase inversion emulsification method is a self-dispersing (phase inversion emulsification) method which includes dispersing a mixed molten material including a resin having self-dispersing ability or solubility and a pigment in water. In addition, the mixed molten material may include a hardening agent or a polymer compound. The mixed molten material may be in a state of being not dissolved but mixed, a state of being dissolved and mixed, or a state including both of the two states. More specific examples of the “phase inversion emulsification method” include those described in JP-A No. 10-140065.

In general, in the phase inversion emulsification method, since the resin functions as a dispersant, a dispersant other than the resin is not necessary. However, in the invention, by using an anionic low-molecular weight surfactant, a pigment dispersion excellent in dispersion stability and filtering property may be obtained.

More specifically, the method for manufacturing a pigment dispersion of the invention may include steps of (1) mixing the water-insoluble resin having an anionic group or a solution in which the resin is dissolved in an organic solvent with a basic compound (i.e., neutralizing agent) for neutralization, (2) obtaining a suspension by mixing the resulting mixture with pigment, and dispersing the pigment using a disperser, etc. to obtain a pigment dispersion, and (3) removing the organic solvent, for example by distillation to coat the pigment with the specific water-insoluble resin having an anionic group and disperse them in an aqueous medium to obtain an aqueous dispersion.

In addition, more specifically, those disclosed in JP-A Nos. 11-2096722 and 11-172180 can be referenced.

The mixing method and the dispersing method are not specifically limited. A commonly used mixing and stirring device may be used. A disperser such as an ultrasonic disperser, a high pressure homogenizer, a ball mill, a roll mill, a bead mill, a high speed stirring type disperser, or the like may be used as necessary.

b) Acid Precipitation Method

In the step of removing at least a part the solvent from the obtained aqueous dispersion, a method for removing an organic solvent by a common method such as a reduced pressure distillation method, or the like may be used without specific limitation. In this step, a part of water may also be removed in addition to a part of the organic solvent.

By removing the organic solvent and converting the dispersion into an aqueous system, a dispersion of the resin-coated carbon black particles wherein the surface of the carbon black particles is coated with the water-insoluble resin can be obtained. In the dispersion obtained accordingly, it is preferable that the organic solvent is substantially removed and the amount of the organic solvent included is preferably 0.2% by mass or less, and more preferably 0.1% by mass or less.

Aqueous Ink for Inkjet Recording

The aqueous ink for inkjet recording of the invention (herein below, sometimes referred to as “aqueous ink”) includes at least one pigment dispersion described above, and as necessary, may further include an water-soluble solvent, a surfactant, and other components such as a preservative and a fungicide.

Having such a configuration, the aqueous ink of the invention may be excellent in dispersion stability, filtering property and discharging property.

The content of the pigment dispersion in the aqueous ink for inkjet recording of the invention is, in terms of the content of carbon black coated with the water-insoluble resin, preferably 1 to 10% by mass, more preferably 2 to 8% by mass and even more preferably, 2 to 6% by mass, from the viewpoint of the dispersion stability of the aqueous ink and the image recording density.

<Water-Soluble Organic Solvent>

The aqueous ink for inkjet recording of the invention preferably includes at least one water-soluble organic solvent. The water-soluble organic solvent can be used for obtaining effects of anti-drying, wetting or penetration promoting. The effect of anti-drying and wetting means an effect for preventing clogging due to aggregate that is produced by deposition and drying of the aqueous ink at a discharge opening of a nozzle. As an anti-drying agent or a wetting agent, a water-soluble organic solvent having a lower vapor pressure compared to water is preferred.

The effect of penetration promoting is an effect for increasing the penetration ability of the ink to paper.

The water-soluble organic solvent that is included in the aqueous ink for inkjet recording of the invention can be selected appropriately from known water-soluble organic solvents, considering the functional activity as an anti-drying agent, a humectant or a penetration promoting agent.

Examples of the water soluble organic solvent include glycerin, 1,2,6-hexanetriol, trimethylol propane, ethylene glycol, propylene glycol, diethylene glycol, triethylene glycol, tetraethylene glycol, pentaethylene glycol, dipropylene glycol, alkane diols such as 2-butene-1,4-diol, 2-ethyl-1,3-hexane diol, 2-methyl-2,4-pentane diol, 1,2-octane diol, 1,2-hexane diol, 1,2-pentane diol, or 4-methyl-1,2-pentane diol (polyhydric alcohols); sugars such as glucose, mannose, fructose, ribose, xylose, arabinose, galactose, aldonic acid, glucitol, maltose, cellobiose, lactose, sucrose, trehalose, or maltotriose; sugar alcohols; hyaluronic acids; so called solid humectants including ureas and the like; alkyl alcohols having 1 to 4 carbon atoms such as ethanol, methanol, butanol, propanol, or isopropanol; glycol ethers such as ethylene glycolmonomethyl ether, ethylene glycolmonoethyl ether, ethylene glycolmonobutyl ether, ethylene glycolmonomethyl ether acetate, diethylene glycolmonomethyl ether, diethylene glycolmonoethyl ether, diethylene glycolmono-n-propyl ether, ethylene glycolmono-iso-propyl ether, diethylene glycolmono-iso-propyl ether, ethylene glycolmono-n-butyl ether, ethylene glycolmono-t-butyl ether, diethylene glycolmono-t-butyl ether, 1-methyl-1-methyoxy butanol, propylene glycolmonomethyl ether, propylene glycolmonoethyl ether, propylene glycolmono-t-butyl ether, propylene glycolmono-n-propyl ether, propylene glycolmono-iso-propyl ether, dipropylene glycolmonomethyl ether, dipropylene glycolmonoethyl ether, dipropylene glycolmono-n-propyl ether, dipropylene glycolmono-iso-propyl ether; 2-pyrrolidone, N-methyl-2-pyrrolidone, 1,3-dimethyl-2-imidazolidinone, formamide, acetamide, dimethyl sulfoxide, sorbitol, sorbitan, acetin, diacetin, triacetin, sulforane and the like. These can be used alone or in combination of two or more.

As an anti-drying agent or a humectant, polyhydric alcohols are useful. Examples thereof include glycerin, ethylene glycol, diethylene glycol, triethylene glycol, propylene glycol, dipropylene glycol, tripropylene glycol, 1,3-butane diol, 2,3-butane diol, 1,4-butane diol, 3-methyl-1,3-butane diol, 1,5-pentane diol, tetraethylene glycol, 1,6-hexane diol, 2-methyl-2,4-pentane diol, polyethylene glycol, 1,2,4-butanetriol, 1,2,6-hexanetriol and the like. These may be used alone or in combination of two or more.

As a penetration agent, polyol compounds are preferred. Examples of aliphatic diol include 2-ethyl-2-methyl-1,3-propane diol, 3,3-dimethyl-1,2-butane diol, 2,2-diethyl-1,3-propane diol, 2-methyl-2-propyl-1,3-propane diol, 2,4-dimethyl-2,4-pentane diol, 2,5-dimethyl-2,5-hexane diol, 5-hexen-1,2-diol, 2-ethyl-1,3-hexane diol and the like. Among these, preferred examples include 2-ethyl-1,3-hexane diol and 2,2,4-trimethyl-1,3-pentane diol.

The organic solvent can be used alone or in combination of two or more.

The content of the organic solvent is preferably in the range of 1 to 60% by mass, and more preferably 5 to 40% by mass in the aqueous ink.

The aqueous ink for inkjet recording of the invention includes water and the amount of water is not specifically limited. A preferred amount of water is 10 to 99% by mass. More preferred amount of water is 30 to 80% by mass, and still more preferred amount of water is 50 to 70% by mass.

<Surfactant>

The aqueous ink for inkjet recording of the invention preferably includes at least one surfactant. The surfactant is employed as an agent for controlling surface tension, and examples thereof include a non-ionic, a cationic, an anionic and a betaine type surfactant.

To achieve good discharge of droplets with an inkjet method, the surfactant is preferably included in an amount which can control the surface tension of the aqueous ink to be in the range of 20 to 60 mN/m. Especially, it is preferred to be included in an amount which can control the surface tension to be in the range of 20 to 45 mN/m. It is more preferred to be included in an amount which can control the surface tension to be in the range of 25 to 40 mN/m.

As the surfactant, a compound which has a structure including both hydrophilic part and hydrophobic part in the molecule can be effectively used. Further, any of an anionic surfactant, a cationic surfactant, an amphoteric surfactant, and a non-ionic surfactant can be used.

Specific examples of an anionic surfactant include sodium dodecylbenzene sulfonate, sodium lauryl sulfate, sodium alkyldiphenyl ether disulfonate, sodium alkylnaphthalene sulfonate, sodium dialkylsulfosuccinate, sodium stearate, potassium oleate, sodium dioctylsulfosuccinate, sodium polyoxyethylenealkyl ether sulfate, sodium polyoxyethylenealkyl ether sulfate, sodium polyoxyethylenealkylphenyl ether sulfate, sodium dialkyl sulfosuccinate, sodium stearate, sodium oleate, sodium t-octylphenoxyethoxypolyethoxyethyl sulfate, and the like. It can be used alone or in combination of two or more.

Examples of a cationic surfactant include a tetraalkyl ammonium salt, an alkyl amine slat, a benzalkonium salt, an alkyl pyridium salt, an imidazolium salt, and the like. Specific examples thereof include dihydroxy ethylstearyl amine, 2-heptadecenyl-hydroxyethyl imidazoline, lauryl dimethylbenzyl ammonium chloride, cetylpyridinium chloride, stearamide methylpyridum chloride and the like.

Examples of an amphoteric surfactant include lauryl dimethyl amino acetic acid betaine, 2-alkyl-N-carboxymethyl-N-hydroxyethyl imidazolinium betaine, coconut oil fatty acid amide propyl dimethyl amino acetic acid betaine, poly octyl polyamino ethyl glycine, and other imidazoline derivatives.

Examples of a non-ionic surfactant include an acetylene glycol surfactant, an acetylene alcohol surfactant, polyoxyethylene alkyl ether, and polyoxyethylene phenyl ether. In the invention, from the viewpoint of suppressing foaming of the aqueous ink, it is preferable to use a non-ionic surfactant, and it is more preferable to use an acetylene glycol surfactant.

Examples of an acetylene glycol surfactant include 2,4,7,9-tetramethyl-5-decin-4,7-diol, 3,6-dimethyl-4-octin-3,6-diol, 3,5-dimethyl-1-hexin-3-ol, substances obtained by 1 to 30 (as an average number) ethylene oxy group(s) or propylene oxy group(s) are added to each of a plural hydroxy groups in any of the above described substances. As the acetylene glycol surfactant, a commercially available product may be used, and examples thereof include OLFINE 1010 and OLFINE STG (both are manufactured by Nisshin Chemical Industry, Ltd.)

Specific examples of polyoxyethylene alkyl ether and polyoxyethyele phenyl ether include polyoxyethylenelauryl ether, polyoxyethylenoctylphenyl ether, polyoxyethyleneoleylphenyl ether, polyoxyethylenenonylphenyl ether, oxyethylene-oxypropylene block copolymer, t-octylphenoxyethylpolyethoxy ethanol, nonylphenoxyethylpolyethoxy ethanol and the like.

In the invention, the surfactant may be used alone or in combination of two or more.

The content of the surfactant in the aqueous ink for inkjet recording is not specifically limited. It is preferably 0.1% by mass or more, more preferably 0.1 to 2.0% by mass, and still more preferably 0.5 to 1.5% by mass.

The aqueous ink for inkjet recording preferably contains an acetylene glycol surfactant as the surfactant in an amount of 0.1 to 2.0% by mass, and more preferably in an amount of 0.5 to 1.5% by mass.

<Other Components>

The aqueous ink for inkjet recording of the invention may include, in addition to the above described components, other components such as resin particles or a polymer latex, an UV absorbing agent, a fade preventing agent, a fungicide, an anti-corrosive agent, an anti-oxidant, an emulsification stabilizer, a preservative, an anti-foaming agent, a viscosity controlling agent, a dispersion stabilizer, a chelating agent and the like, if necessary.

Examples of the resin particles include particles of an acrylic resin, a vinyl acetate resin, a styrene-butadiene resin, a vinyl chloride resin, an acryl-styrene resin, a butadiene resin, a styrene resin, a cross linked acrylic resin, a cross linked styrene resin, a benzoguanamaine resin, a phenol resin, a silicone resin, an epoxy resin, a urethane resin, a paraffinic resin, or a fluorine-based resin or a polymer latex including them.

An acrylic resin, an acryl-styrene resin, a styrene resin, a cross linked acrylic resin, and a cross linked styrene resin can be mentioned as a preferred example.

The weight average molecular weight of the resin particles is preferably 10,000 or more but 200,000 or less. More preferably, it is 100,000 or more but 200,000 or less.

The average particle diameter of the resin particles is preferably in the range of 10 nm to 1 m. More preferably, it is in the range of 10 nm to 200 nm. Still more preferably, it is in the range of 20 nm to 100 nm. Particularly more preferably, it is in the range of 20 nm to 50 nm.

The addition amount of the resin particles is preferably 0.5 to 20% by mass with respect to the ink. More preferably, it is 3 to 20% by mass, and still more preferably it is 5 to 15% by mass.

The glass transition temperature (Tg) of the resin particles is preferably 30° C. or more. More preferably, it is 40° C. or more. Still more preferably, it is 50° C. or more.

The particle diameter distribution of polymer particles is not specifically limited and any one having broad particle diameter distribution or monodisperse particle diameter distribution may be used. Further, two or more kinds of polymer particles having monodisperse particle diameter distribution may be used as a mixture.

Examples of the UV absorbing agent include benzophenone type UV absorbing agent, benzotriazole type UV absorbing agent, salicylate type UV absorbing agent, cyanoacrylate type UV absorbing agent, nickel complex salt type UV absorbing agent, and the like.

As for the fade preventing agent, various types of organic or metal complex fade preventing agent can be used. Examples of the organic fade preventing agent include hydroquinones, alkoxypheonols, dialkoxyphenols, phenols, anilines, amines, indanes, chromanes, alkoxyanilines, heterocycles and the like. Examples of the metal complex include a nickel complex, a zinc complex and the like.

Examples of the anti-oxidant include phenol type anti-oxidant (including a hindered phenol type anti-oxidant), amine type anti-oxidant, sulfur type anti-oxidant, phosphorous type anti-oxidant and the like.

As for the fungicide, sodium dehydroacetate, sodium benzoate, sodium pyridinethion-1-oxide, p-hydroxybenzoic acid ethyl ester, 1,2-benzisothiazolin-3-one, sodium sorbate, sodium pentachlorophenolate and the like can be mentioned. The fungicide is preferably used in an amount of 0.02 to 1.00% by mass in the ink.

Examples of the preservative include preservatives containing benzisothiazolone as an active ingredient (for example, PROXEL XL-2, PROXEL BDN, PROXEL BD20, PROXEL GXL, PROXEL LV and PROXEL TN (manufactured by Arch Chemicals, Inc.) and DENICEDE BIT and DENICEDE NIPA (manufactured by Nagase Chemicals Ltd.)), preservatives containing octylisothiazolone as alkylisothiazolone (for example, NS-800H, NS800G and NS-800P (manufactured by Nagase Chemicals Ltd.)), preservatives containing chloroisomethylthiazolone as chloroalkylisothiazolone (for example, NS-500W, NS-80D, NS-CG, NS-TM and NS-RS (manufactured by Nagase Chemicals Ltd.)), preservatives containing bromonitro alcohol as an active ingredient (for example, BRONOPOL, MIACIDE BT and MIACIDE AS (manufactured by Nagase Chemicals Ltd.)), preservatives containing chloroxylenol as an active ingredient (for example, PCMX (manufactured by Nagase Chemicals Ltd.)), and preservatives containing, as an active ingredient, an oxazolidine-based compound, a mixture thereof or a denatured product thereof (for example, NS-BP, DENICEDE BIT-20N, DENICEDE SPB, SANISET HP, Microstat S520, SANISET SK2, DENICEDE NS-100, DENICEDE BF-1, DENICEDE C3H, SANISET 161, DENICEDE CSA, DENICEDE CST, DENICEDE C3, DENICEDE OMP, DENICEDE XR-6, DENICEDE NM, MORDENIZE N760, DENISAT P4, DENISAT P-8 and DENISAT CHR (all manufactured by Nagase Chemicals Ltd.). Among them, those preservatives containing an oxazolidine-based compound as an active ingredient, those containing chloroisomethylthiazolone as an active ingredient and those containing benzisothiazolone as an active ingredient are highly effective and preferable. From the viewpoint of suppressing resistant bacteria, it is more preferable to use a preservative containing two or more components which are not too similar each other in structure than a preservative containing a single active ingredient.

Examples of the chelating agent (metal ion-capturing agent) include sodium ethylenediamine tetraacetate, sodium nitrilotriacetate, sodium hydroxy ethylethylenediamine triacetate, sodium diethylene triamine pentaacetate, sodium uramyldiacetate and the like.

Examples of the anti-corrosive agent include acidic sulfite salt, sodium thiosulfate, ammonium thiodiglycolate, diisopropyl ammonium nitrite, pentaerythritol tetranitrate, dicyclohexyl ammonium nitrite, benzotriazole and the like. Among these anti-corrosive agents, dicyclohexyl ammonium nitrite and benzotriazole are more effective.

The anti-corrosive agent is used to suppress rusting of a metal head, and may be effectively used when a plated surface which is susceptible to rusting is used.

It is preferable that the amount (A) of the preservative added is 0.01% by mass to 0.1% by mass, the amount (B) of the metal ion-capturing agent added is 0.01% by mass to 0.5% by mass, the amount (C) of the anti-corrosive agent added is 0.01% by mass to 0.2% by mass, and A+B+C is 0.03% by mass to 0.8% by mass.

When the amount (A) of the preservative added is 0.01% by mass or more, the preservative effect of the ink can be sufficiently obtained. When the amount (A) is 0.1% by mass or less, the ink may have more excellent long-term storage stability.

When the amount (C) of the anti-corrosive agent added is 0.01% by mass or more, the rusting of metal portion of a head, particularly in the vicinity of the tip of a nozzle, can be effectively suppressed, even when the inkjet recording apparatus is used over a long period time. When the amount (C) is 0.2% by mass or less, a colorant in the ink may become more excellent in stability, and the long-term storage stability of the ink may be further improved.

Where the amount (B) of the metal ion-capturing agent is 0.01% by mass or more, the use of the aqueous ink of the invention, when the ink is charged in an ink cartridge having, in an ink chamber, urethane foam possibly containing a trace amount of metal ions, may effectively suppress the generation of foreign matter. When the amount (B) is 0.5% by mass or less, a colorant in the ink may become more excellent in stability, and the long-term storage stability may be further improved.

—Physical Properties of Aqueous Ink Composition—

The surface tension of the aqueous ink for inkjet recording according to the invention (at 25° C.) is preferably 20 mN/m or more but 60 mN/m or less. More preferably, it is 20 mN/m or more but 45 mN/m or less. Still more preferably, it is 25 mN/m or more but 40 mN/m or less.

The surface tension is measured by using AUTOMATIC SURFACE TENSIOMETER CBVP-Z (manufactured by Kyowa Interface Science Corp.) under the condition of testing the aqueous ink at 25° C.

The viscosity of the aqueous ink for inkjet recording according to the invention at 20° C. is preferably 1.2 mPa·s or more but 15.0 mPa·s or less, more preferably 2 mPa·s or more but less than 13 mPa·s, and still more preferably 2.5 mPa·s or more but less than 10 mPa·s.

The viscosity is measured by using VISCOMETER TV-22 (manufactured by TOKI SANGYO CO. LTD) under the condition of testing the aqueous ink at 20° C.

The aqueous ink for inkjet recording according to the invention can be used for forming a color image having multiple colors (e.g., full color image). For forming a full color image, an ink composition having magenta hue, an ink composition having cyan hue, and an ink composition having yellow hue, and optionally ink compositions having other hues including red (R), green (G), blue (B), white (W) or an ink composition having so called specific color in a printing field can be used.

Method for Manufacturing Aqueous Ink for Inkjet Recording

The method for manufacturing an aqueous ink for inkjet recording of the invention includes a step of mixing a water-insoluble resin, a carbon black, a neutralizing agent, an organic solvent, an anionic low-molecular weight surfactant and an aqueous medium to form an aqueous dispersion, a step of removing at least a part of the organic solvent from the aqueous dispersion to form a pigment dispersion, and a step of preparing an aqueous ink for inkjet recording using the pigment dispersion. The method may further include additional step(s), as necessary.

The step of mixing a water-insoluble resin, a carbon black, a neutralizing agent, an organic solvent, an anionic low-molecular weight surfactant and an aqueous medium to form an aqueous dispersion and the step of removing at least a part of the organic solvent from the aqueous dispersion to form a pigment dispersion are similar to the step of mixing a water-insoluble resin, a carbon black, a neutralizing agent, an organic solvent, an anionic low-molecular weight surfactant and an aqueous medium to form an aqueous dispersion, and the step of removing at least a part of the organic solvent from the aqueous dispersion in the above “Method for Manufacturing Pigment Dispersion” respectively, and the descriptions of the these steps in “Method for Manufacturing Pigment Dispersion” are applicable to the step of mixing a water-insoluble resin, a carbon black, a neutralizing agent, an organic solvent, an anionic low-molecular weight surfactant and an aqueous medium to form an aqueous dispersion and the step of removing at least a part of the organic solvent from the aqueous dispersion to form a pigment dispersion in the method for manufacturing an aqueous ink for inkjet recording.

In the invention, the pigment dispersion obtained as described above may be mixed with additional component(s) such as a water-soluble organic solvent, a surfactant, a preservative, a fungicide and the like, which may be selected as necessary, and an aqueous ink of inkjet recording may be produced.

By the above-described method, an aqueous ink for inkjet recording that is excellent in stability, filtering property and discharge property can be produced efficiently.

—Recording Mode—

The aqueous ink for inkjet recording of the invention can used in a recording mode in which an image is recorded on a recording medium by discharging with an inkjet method according to image information to be recorded (first recording mode).

Alternatively, the aqueous ink of the invention can also be used in a recording mode in which an aqueous liquid composition (i.e., a aggregating liquid), which includes a component capable of causing aggregation of pigment particles such as carbon black in an aqueous ink when admixed with it, is used so that an image is recorded by contacting the aqueous ink with the aqueous liquid composition (second recording mode).

—Aqueous Liquid Composition—

Herein below, the aqueous liquid composition that is used for the second recording mode will be explained.

The aqueous liquid composition includes an aggregating component which can cause aggregation of pigment contained in the aqueous ink when admixed with it, and if necessary, it may include further components.

—Aggregating Component—

The aqueous liquid composition includes at least one aggregating component which causes aggregation of pigment particles such as carbon black included in an aqueous ink. When the aqueous liquid composition is admixed with the aqueous ink that is discharged by an inkjet method, aggregation of the pigment, etc., stably dispersed in the aqueous ink, is promoted.

An example of the aqueous liquid composition includes a liquid composition which can cause an aggregate by changing pH of the aqueous ink. In this case, pH (at 25° C.) of the aqueous liquid composition is preferably 6 or less, and more preferably 4 or less. Among these, pH (at 25° C.) is in the range of 1 to 4, and more preferably in the range of 1 to 3. At the same time, pH (at 25° C.) of the aqueous ink is preferably 7.5 or more, and more preferably 8 or more.

In particular, in terms of image density, resolution and performing high speed inkjet recording, pH (at 25° C.) of the aqueous ink is preferably 7.5 or more, and pH (at 25° C.) of the aqueous liquid composition is preferably 4 or less.

Examples of aggregating components which cause aggregation of pigment particles such as carbon black include polyvalent metal salts, an organic acid, polyallylamine, and derivatives thereof, etc.

Preferred examples of the polyvalent metal salts include salts of an alkaline earth metal of Group 2 of the periodic table (for example, magnesium and calcium), a transition metal of Group 3 of the periodic table (for example, lanthanide), a cation of Group 13 of the periodic table (for example, aluminum), lanthanides (for example, neodymium) and the like. As a salt of these metals, carboxylic acid salt (formic acid, acetic acid, benzoic acid salt and the like), nitric acid salt, chlorides, and thiocyanic acid salt are preferred. Among these, more preferred are calcium salt or magnesium salt of a carboxylic acid (formic acid, acetic acid, benzoic acid salt and the like), calcium salt or magnesium salt of nitric acid, calcium chloride, magnesium chloride and calcium salt or magnesium salt of thiocyanic acid.

The organic acid is preferably selected from polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furane carboxylic acid, pyridine carboxylic acid, coumarine acid, thiophen carboxylic acid, nicotinic acid, or derivatives of these compounds, or salts of them.

The aggregating components can be used alone or in combination of two or more.

The content of the aggregating components which cause the aggregation of a pigment, etc. is preferably 1 to 20% by mass, more preferably 5 to 20% by mass, and still more preferably 10 to 20% by mass in the aqueous liquid composition.

—Image Recording Method—

The aqueous ink for inkjet recording of the invention can be used for any of the first recording mode or second recording mode.

In the first recording mode, an ink application step is included in which the black colored aqueous ink of the invention is applied on a recording medium according to an inkjet method.

In the second recording mode, an ink application step in which the black colored aqueous ink of the invention is applied on a recording medium according to an inkjet method, and an aggregating component application step in which the aqueous liquid composition including a component which causes aggregation of pigment particles, etc. such as carbon black and the like contained in the aqueous ink is applied on the recording medium are included, so that the aqueous ink and the aqueous liquid composition are brought into contact with each other to form an image.

In any of the first recording mode or second recording mode, when the aqueous ink that is obtained using, as a colorant, a pigment dispersion manufactured by a method for manufacturing a pigment dispersion of the present invention is used, a favorable dispersion stability may be enabled, and a black image with high color density can be obtained, and also failure in ink discharge directivity at the time of discharging ink is inhibited because adhesion or deposition of the aggregate at a head nozzle part is reduced and the adhered aggregate can be easily removed. As a result, the occurrence of an image problem such as white spots, etc. is inhibited, so that an image with high resolution can be obtained. Still further, frequency of maintenance of a discharge apparatus can be lowered and the maintainability can be improved.

In the ink application step, the aqueous ink is applied by an inkjet method. Specifically, to a medium to be recorded, i.e., a plain paper, a resin coated paper, for example paper for an inkjet printer as described in publications of JP-A Nos. 8-169172, 8-27693, 2-276670, 7-276789, 9-323475, 62-238783, 10-153989, 10-217473, 10-235995, 10-337947, 10-217597, 10-337947, a film, paper for electrophotography, cloth, glass, a metal, or a porcelain, the aqueous ink is discharged by energy supply to form a colored image. In addition, as a method for inkjet recording preferred for the invention, those disclosed in the paragraph Nos. 0093-0105 of JP-A No. 2003-306623 can be used.

Inkjet method is not specifically limited and may be any of known methods, for example, a charge control method which includes discharging ink using an electrostatic inducing force, drop on demand method (i.e., pressure pulse method) which utilizes vibration pressure of a piezoelectric element, a sonic inkjet method which includes discharging ink by using radiation pressure caused when the electric signal is converted into a sonic beam and radiated to the ink, or a thermal inkjet method (registered trademark; Bubblejet) which includes forming air bubbles by heating ink and using the pressure generated therefrom. As the inkjet method, the method which has been disclosed in JP-A No. 54-59936 and includes using a drastic volume change in ink by the action of heat energy, and discharging ink from a nozzle based on the working power generated from the change can be effectively used.

In addition, examples of the inkjet method include a method which includes discharging many times a small volume of the ink with low concentration (so called, photoink), a method which includes improving the quality of image by using multiple inks having the same color but with different concentration, or a method which includes using a colorless and transparent ink.

In addition, the inkjet head that is used for the inkjet method can be either on demand type or a continuous type. Further, specific examples of a discharging method include electromechanical transducer type (for example, single cavity type, double cavity type, bender type, piston type, share mode type, shared wall type and the like), electromechanical transducer type (for example, thermal inkjet type, Bubblejet type (registered trademark)), an electrostatic suction type (for example, electric field control type, slit jet type and the like) and a discharge type (for example, a spark jet type and the like) and the like. Any of these discharge methods can be used.

Further, the ink nozzle which is used for recording according to the inkjet method is not specifically limited. Rather, depending on the purpose of use, it can be appropriately selected.

In the aggregating component application step in the second recording mode, the aqueous liquid composition is applied on a recording medium either before or after the application of the aqueous ink. The application of the aqueous liquid composition can be carried out by a known method such as a coating method, an inkjet method or an dipping method. As a coating method, a known coating method using a bar coater, an extrusion die coater, an air doctor coater, a blade coater, a rod coater, a knife coater, a squeeze coater, a reverse roll coater, a bar coater and the like can be used. Specific details about an inkjet method are the same as those described above.

In the second recording mode of the invention, it is preferable that the aqueous liquid composition is applied first and then an ink application step is carried out. That is, in a preferred exemplary embodiment, before applying the aqueous ink to a recording medium, the aqueous liquid composition which causes aggregation of pigment included in the aqueous ink is applied, and thereafter, the aqueous ink is applied to be in contact with the aqueous liquid composition, which has been already applied to the recording medium, so as to form an image. In accordance with this, high speed inkjet recording can be performed, and an image with high density and high resolution can be obtained by the high speed recording.

Further, the aggregation component application step preferably includes a step of removing at lest a part of the solvent in the aqueous liquid composition.

When recording an image, a polymer latex compound may be also used for obtaining gloss or water resistance or improving weatherability. The period during which the polymer latex compound is applied may be any of before and after the application of the aqueous ink. Alternatively, they may be applied simultaneously. Thus, the polymer latex compound may be used in a mode in which it is applied to a recording medium, added to the aqueous ink, or provided as a separate liquid including the polymer latex compound.

Specifically, the methods that are disclosed in JP-A Nos. 2002-166638 (Japanese Patent Application No. 2000-363090), 2002-121440 (Japanese Patent Application No. 2000-315231), 2002-154201 (Japanese Patent Application No. 2000-354380), 2002-144696 (Japanese Patent Application No. 2000-343944), and 2002-080759 (Japanese Patent Application No. 2000-268952) can be preferably used.

The method for recording an image according to the invention may include an additional step in addition to the ink application step and the aggregating component application step. Additional step is not specifically limited and can be appropriately selected depending on a specific purpose. For example, drying and removing an organic solvent that is included in the aqueous ink applied to a recording medium, melt-fixing a polymer latex or resin particles included in the aqueous ink, and the like can be mentioned.

Another example of a method for recording an image of the invention involves using an intermediate transfer body as a recording medium to which an image is first formed, recording an image on the intermediate transfer body, and then transferring the image recorded on the intermediate transfer body to the medium to be recorded.

In case of the second recording mode, an exemplary method may include an ink application step in which an intermediate transfer body is used as a recording medium to which an image is first formed and to this intermediate transfer body the aqueous ink of the invention described before is applied by an inkjet method, an aggregating component application step in which an aqueous liquid composition including component that can cause aggregation of the pigment included in the aqueous ink is applied to the intermediate transfer body so that an image is formed on the intermediate transfer body by contacting the aqueous ink with the aqueous liquid composition, and a transfer step in which the image formed on the intermediate transfer body is transferred to a final recording medium.

In this case, same as described above, other steps such as a drying and removing process, a heating and fixing process and the like can be further included. The aggregating component application step is preferably carried out before the ink application step.

### EXAMPLES

Herein below, the invention is explained in greater detail in view of the following Examples. However, the invention is not limited to the following Examples. In addition, unless specifically mentioned otherwise, the term “part” is based on the mass.

The weight average molecular weight was measured by gel permeation chromatography (GPC). As a GPC instrument, HLC-8020GPC (manufactured by Tosoh Corp.) is used and three columns of TSKGEL, SUPER MULTIPORE HZ-H (manufactured by Tosoh Corp., 4.6 mmID×15 cm) were used. THF (tetrahydrofuran) was used as an eluent. As the measurement conditions, the sample concentration was 0.35% by mass, the flow rate was 0.35 ml/min, the sample injection amount was 10 μl, and the measurement temperature was 40° C., and an IR detector was used for detection. The calibration curve was established by using eight samples of “STANDARD SAMPLE TSK STANDARD, POLYSTYRENE” (manufactured by Tosoh Corp.): F-40, F-20, F-4, F-1, A-5000, A-2500, A-1000 and n-propylbenzene.

### Synthetic Example 1

—Synthesis of Resin Dispersant (Water-Insoluble Resin) P-1—

To a 1,000 ml three-neck flask which is equipped with a stirrer and a condenser, methylethyl ketone (88 g) was placed and then heated to 72° C. under nitrogen atmosphere. To this flask, a solution in which 0.85 g of dimethyl-2,2′-azobisisobutyrate, 70 g of phenoxyethylmethacrylate, 10 g of methacrylic acid and 20 g of methylmethacrylate 20 g were dissolved in 50 g of methylethyl ketone was added dropwise over three hours. After completion of the dropwise addition, the content in the flask was allowed to react for an additional one hour. Then, a solution in which 0.42 g of dimethyl-2,2′-azobisisobutyrate was dissolved in 2 g of methylethyl ketone was added thereto, the temperature of the resultant mixture was raised to 78° C. and maintained at 78° C. for four hours while heating. The resulting reaction solution was subjected to re-precipitation twice with an excess amount of hexane, and the precipitated resin was dried and 96.5 g of phenoxyethylmethacrylate/methylmethacrylate/methacrylic acid (copolymerization ratio [weight ratio]=70/20/10) copolymer (resin dispersant P-1, water-insoluble resin) was obtained.

The composition of the thus obtained resin dispersant P-1 was confirmed with ¹H-NMR. The weight average molecular weight (Mw) measured with GPC was 43,500. The acid number of the polymer obtained according to the measurement based on the method described in JIS Standard (JIS K 0070:1992), the disclosure of which is incorporated by reference herein, was 65.2 mg KOH/g.

—Synthesis of Resin Dispersants P-2 and P-3—

Except that phenoxyethylmethacrylate 70 g, methacrylic acid 10 g, and methylmethacrylate 20 g for the synthesis of the resin dispersant P-1 were changed to the monomers and the proportions for P-2 and P-3 shown in Table 1 respectively, and the conditions were changed so as to obtain the weight average molecular weights (Mw) of P-2 and P-3 shown in Table 1 respectively, resin dispersants P-2 and P-3 were synthesized in almost the same manner as the synthesis of a resin dispersant P-1.

### Example 1

—Preparation of Dispersion C1 of Resin-Coated Carbon Black Particles (Pigment Dispersion)—

The following components were mixed and dispersed with a beads mill using 0.1 mm φ zirconia beads for 3 to 6 hours. From the resulting dispersion, the methyl ethyl ketone was removed at 55° C. under reduced pressure, and further, a part of the water was removed, whereby a dispersion of resin-coated carbon black particles having a carbon black concentration of 10.0 mass % was prepared.

(Composition of Dispersion C1 of Resin-Coated Carbon Black Particles)

| | | |
|---|---|---|
| Carbon black | 10.0 | parts |
| (trade name: NIPEX 180-IQ manufactured by Degussa; | | |
| specific surface area by BET method: 260 m²/g) | | |
| Resin dispersant P-1 (water-insoluble resin) | 4.5 | parts |
| Methyl ethyl ketone (organic solvent) | 30.5 | parts |
| 1 mol/L NaOH aqueous solution (neutralizing agent) | 6.3 | parts |
| 10% sodium oleate aqueous solution | 10.0 | parts |
| (anionic low-molecular weight surfactant) | | |
| Ion-exchanged water | 88.7 | parts |

—Preparation of Aqueous Ink for Inkjet Recording—

Then, the resulting dispersion of resin-coated carbon black particles was used to prepare an aqueous ink with the following composition. The pH of the aqueous ink at 25° C. was 8.9.

<Composition of Aqueous Ink C1>

| | | |
|---|---|---|
| Dispersion C1 of resin-coated carbon black | 40.0 | parts |
| particles described above | | |
| Glycerin | 15.0 | parts |
| Diethylene glycol monoethyl ether | 10.0 | parts |
| PROXEL XL-2 | 0.05 | part |
| (preservative manufactured by Arch Chemicals | | |
| Japan) | | |
| Benzotriazole | 0.05 | part |
| OLFINE E1010 (manufactured by Nisshin | 1.0 | part |
| Chemicals Co., Ltd.) | | |
| Ion-exchanged water | 33.9 | parts |

(Evaluation)

With respect to the dispersion of resin-coated carbon black particles and the aqueous ink as described above, the following measurement and evaluation were performed. The measurement and evaluation results are shown in Table 1 below.

(Particle Size Measurement of Resin-Coated Carbon Black Particles)

The resulting dispersion of resin-coated carbon black particles (pigment dispersion) was measured for its volume-average particle size by a dynamic light scattering method using a particle size distribution measuring instrument NANOTRAC UPA-EX 150 (trade name, manufactured by NIKKISO Co., Ltd.). In this measurement, 10 mL of ion-exchanged water was added to 30 μL of the resin-coated carbon black particle dispersion to prepare a measurement sample, and the thus prepared sample was then measured at a controlled temperature of 25° C. The measurement results are shown in Table 1.

(Filtering Property of Pigment Dispersion)

15 mL of the resulting dispersion of resin-coated carbon black particles was filtrated with a 25 mm φ membrane filter having a pore size of 3 μm (manufactured by Advantec Toyo Kaisha, Ltd.) at a reduced pressure of 0.03 MPa and evaluated under the following evaluation criteria. The evaluation results are shown in Table 1.

—Evaluation Criteria—
AA: The time required for filtration is less than 10 seconds.
A: The time required for filtration is 10 seconds or more and less than 30 seconds.
B: The time required for filtration is 30 seconds or more and less than 1 minute.
C: The time required for filtration is 1 minute or more.

(Discharge Stability)

An inkjet apparatus equipped with an prototype print head with 600 dpi and 256 nozzles was prepared as an inkjet recording apparatus. An aqueous ink for inkjet recording was prepared using the resulting resin-coated carbon black particle dispersion and then stored for 7 days in a thermostat bath at 60° C., and the resulting aqueous ink was charged into the inkjet recording apparatus.

The aqueous ink was ejected continuously for 30 minutes via the head onto TOKUBISHI art paper (trade name, manufactured by Mitsubishi Paper Mills Limited.), after that, in maintenance operation, the head was pressurized at a pressure of 15 KPa for 10 seconds and then wiped with a clean wiper FF-390c (trade name, manufactured by Kuraray Co., Ltd.). Thereafter the aqueous ink was further ejected for 5 minutes, and after the 5 minutes, an image with 5% to 100% (at intervals of 5%) gray-scale patches recorded (the size of 1 patch: 1 cm×1 cm) on TOKUBISHI art paper (manufactured by Mitsubishi Paper Mills Limited.) was obtained. Then, the image was observed and the observed image was visually evaluated under the following evaluation criteria.

<Evaluation Criteria>
A: No image deformation attributable to white dots is observed.
B: Image deformation is recognized with many image defects such as white dots.

(Abrasion Resistance)

In the same manner as described above, an inkjet apparatus equipped with an experimental print head with 600 dpi and 256 nozzles was prepared as an inkjet recording apparatus. An aqueous ink for inkjet recording was prepared using the resulting resin-coated carbon black particle dispersion and then stored for 7 days in a thermostat bath at 60° C., and the resulting aqueous ink was charged into the inkjet recording apparatus.

With the inkjet recording apparatus, a 100% coverage pattern was printed on FX-L paper (manufactured by Fuji Xerox Co., Ltd.), and another unused FX-L paper (blank paper) was placed thereon and pressed against the pattern under a loading of 4.9×10⁴ N/m², and the ink thus transferred to the unused FX-L paper was sensorily evaluated with the naked eye under the following criteria with a previously prepared boundary sample. The evaluation results are shown in Table 1.

<Evaluation Criteria>
AA: Not transferred.
A: Slightly transferred.
B: Transferred but at a practically unproblematic level.
C: Ink transfer is conspicuous. Practically problematic.

### Example 2

An aqueous ink for inkjet recording was prepared and evaluated in the same manner as in Example 1 except that a resin dispersant P-2 was used in place of the resin dispersant P-1 (water-insoluble resin) to prepare a resin dispersion.

### Example 3

An aqueous ink for inkjet recording was prepared and evaluated in the same manner as in Example 1 except that a resin dispersant P-3 was used in place of the resin dispersant P-1 (water-insoluble resin) to prepare a resin dispersion.

### Example 4

An aqueous ink for inkjet recording was prepared and evaluated in the same manner as in Example 1 except that in preparation of the dispersion C1 of resin-coated carbon black particles (pigment dispersion) in Example 1, the composition of the dispersion of resin-coated carbon black particles was changed as follows.

(Composition of Dispersion C4 of Resin-Coated Carbon Black Particles)

| | | |
|---|---|---|
| Carbon black | 10.0 | parts |
| (trade name: NIPEX 180-IQ, manufactured | | |
| by Degussa) | | |
| Resin dispersant P-1 (water-insoluble resin) | 2.0 | parts |
| Methyl ethyl ketone | 24.0 | parts |
| 1 mol/L NaOH aqueous solution | 2.8 | parts |
| 10% sodium oleate aqueous solution | 1.0 | part |
| (anionic low-molecular weight surfactant) | | |
| Ion-exchanged water | 80.2 | parts |

### Example 5

An aqueous ink for inkjet recording was prepared and evaluated in the same manner as in Example 1 except that in preparation of the dispersion C1 of resin-coated carbon black particles (pigment dispersion) in Example 1, the composition of the dispersion of resin-coated carbon black particles was changed as follows.

(Composition of Dispersion C5 of Resin-Coated Carbon Black Particles)

| | | |
|---|---|---|
| Carbon black | 10.0 | parts |
| (trade name: NIPEX 180-IQ, manufactured | | |
| by Degussa) | | |
| Resin dispersant P-1 (water-insoluble resin) | 6.0 | parts |
| Methyl ethyl ketone | 29.0 | parts |
| 1 mol/L NaOH aqueous solution | 8.4 | parts |
| 10% sodium oleate aqueous solution | 1.0 | part |
| (anionic low-molecular weight surfactant) | | |
| Ion-exchanged water | 95.6 | parts |

### Example 6

An aqueous ink for inkjet recording was prepared and evaluated in the same manner as in Example 1 except that in preparation of the dispersion C1 of resin-coated carbon black particles (pigment dispersion) in Example 1, the composition of the dispersion of resin-coated carbon black particles was changed as follows.

(Composition of Dispersion C6 of Resin-Coated Carbon Black Particles)

| | | |
|---|---|---|
| Carbon black | 10.0 | parts |
| (trade name: NIPEX 180-IQ, manufactured | | |
| by Degussa) | | |
| Resin dispersant P-1 (water-insoluble resin) | 4.5 | parts |
| Methyl ethyl ketone | 30.5 | parts |
| 1 mol/L NaOH aqueous solution | 6.3 | parts |
| 1% sodium oleate aqueous solution | 0.1 | part |
| (anionic low-molecular weight surfactant) | | |
| Ion-exchanged water | 98.7 | parts |

### Example 7

An aqueous ink for inkjet recording was prepared and evaluated in the same manner as in Example 1 except that in preparation of the dispersion C1 of resin-coated carbon black particles (pigment dispersion) in Example 1, the composition of the dispersion of resin-coated carbon black particles was changed as follows.

(Composition of Dispersion C7 of Resin-Coated Carbon Black Particles)

| | | |
|---|---|---|
| Carbon black | 10.0 | parts |
| (trade name: NIPEX 180-IQ, manufactured | | |
| by Degussa) | | |
| Resin dispersant P-1 (water-insoluble resin) | 4.5 | parts |
| Methyl ethyl ketone | 30.5 | parts |
| 1 mol/L NaOH aqueous solution | 6.3 | parts |
| 10% sodium oleate aqueous solution | 20.0 | parts |
| (anionic low-molecular weight surfactant) | | |
| Ion-exchanged water | 78.7 | parts |

### Example 8

An aqueous ink for inkjet recording was prepared and evaluated in the same manner as in Example 1 except that in preparation of the dispersion C1 of resin-coated carbon black particles (pigment dispersion) in Example 1, the composition of the dispersion of resin-coated carbon black particles was changed as follows.

(Composition of Dispersion C8 of Resin-Coated Carbon Black Particles)

| | | |
|---|---|---|
| Carbon black | 10.0 | parts |
| (trade name: NIPEX 180-IQ, manufactured | | |
| by Degussa) | | |
| Resin dispersant P-2 (water-insoluble resin) | 4.5 | parts |
| Methyl ethyl ketone | 30.5 | parts |
| 1 mol/L NaOH aqueous solution | 6.9 | parts |
| 1% oleoyl methyl taurine sodium aqueous | 0.5 | part |
| solution (anionic low-molecular weight | | |
| surfactant) | | |
| Ion-exchanged water | 97.6 | parts |

### Example 9

An aqueous ink for inkjet recording was prepared and evaluated in the same manner as in Example 1 except that in preparation of the dispersion C1 of resin-coated carbon black particles (pigment dispersion) in Example 1, the composition of the dispersion of resin-coated carbon black particles was changed as follows.

(Composition of Dispersion C9 of Resin-Coated Carbon Black Particles)

| | | |
|---|---|---|
| Carbon black | 10.0 | parts |
| (trade name: NIPEX 180-IQ, manufactured | | |
| by Degussa) | | |
| Resin dispersant P-2 (water-insoluble resin) | 4.5 | parts |
| Methyl ethyl ketone | 30.5 | parts |
| 1 mol/L NaOH aqueous solution | 6.9 | parts |
| 1% sodium 2-ethylhexylsulfosuccinate | 0.5 | part |
| aqueous solution (anionic low-molecular | | |
| weight surfactant) | | |
| Ion-exchanged water | 97.6 | parts |

### Example 10

An aqueous ink for inkjet recording was prepared and evaluated in the same manner as in Example 1 except that in preparation of the dispersion C1 of resin-coated carbon black particles (pigment dispersion) in Example 1, the composition of the dispersion of resin-coated carbon black particles was changed as follows.

(Composition of Dispersion C10 of Resin-Coated Carbon Black Particles)

| | | |
|---|---|---|
| Carbon black | 10.0 | parts |
| (trade name: NIPEX 180-IQ, manufactured | | |
| by Degussa) | | |
| Resin dispersant P-2 (water-insoluble resin) | 4.5 | parts |
| Methyl ethyl ketone | 30.5 | parts |
| 1 mol/L NaOH aqueous solution | 6.9 | parts |
| 1% sodium dodecylbenzenesulfonate | 0.5 | part |
| aqueous solution (anionic low-molecular | | |
| weight surfactant) | | |
| Ion-exchanged water | 97.6 | parts |

### Comparative Example 1

An aqueous ink for inkjet recording was prepared and evaluated in the same manner as in Example 1 except that in preparation of the dispersion C1 of resin-coated carbon black particles (pigment dispersion) in Example 1, the composition of the dispersion of resin-coated carbon black particles was changed as follows.

(Composition of Dispersion H1 of Resin-Coated Carbon Black Particles)

| | | |
|---|---|---|
| Carbon black | 10.0 | parts |
| (trade name: NIPEX 180-IQ, manufactured | | |
| by Degussa) | | |
| Resin dispersant P-1 (water-insoluble resin) | 4.5 | parts |
| Methyl ethyl ketone | 30.5 | parts |
| 1 mol/L NaOH aqueous solution | 6.3 | parts |
| Ion-exchanged water | 98.7 | parts |

### Comparative Example 2

An aqueous ink for inkjet recording was prepared and evaluated in the same manner as in Comparative Example 1 except that a resin dispersant P-2 (water-insoluble resin) was used in place of the resin dispersant P-1 (water-insoluble resin).

### Comparative Example 3

An aqueous ink for inkjet recording was prepared and evaluated in the same manner as in Comparative Example 1 except that a resin dispersant P-3 (water-insoluble resin) was used in place of the resin dispersant P-1 (water-insoluble resin).

### Comparative Example 4

An aqueous ink for inkjet recording was prepared and evaluated in the same manner as in Example 1 except that although in preparation of the dispersion C1 of resin-coated carbon black particles (pigment dispersion) in Example 1, the water insoluble resin was used, in preparation of the dispersion of carbon black particles in Comparative Example 4, a pigment dispersion was prepared as follows without using a water-insoluble resin.

—Preparation of Dispersion H4 of Carbon Black Particles (Pigment Dispersion)—

The following components were mixed and dispersed with a beads mill using 0. 1 mm φ zirconia beads for 3 to 6 hours, and a dispersion of carbon black particles was prepared such that the density of carbon black reached 10.0% by mass.

Composition of Dispersion H4 of Carbon Black Particles

| | | |
|---|---|---|
| Carbon black | 10.0 | parts |
| (trade name: NIPEX 180-IQ, manufactured | | |
| by Degussa) | | |
| 10% sodium oleate aqueous solution | 20.0 | parts |
| (anionic low-molecular weight surfactant) | | |
| Ion-exchanged water | 70.0 | parts |

### Comparative Example 5

An aqueous ink for inkjet recording was prepared and evaluated in the same manner as in Comparative Example 4 except that in preparation of the dispersion H4 of carbon black particles (pigment dispersion) in Comparative Example 4, the composition of the pigment dispersion was changed as follows.

(Composition of Dispersion H5 of Carbon Black Particles)

| | | |
|---|---|---|
| Carbon black | 10.0 | parts |
| (trade name: NIPEX 180-IQ, manufactured | | |
| by Degussa) | | |
| 1% oleoylmethyltaurine sodium aqueous | 25.0 | parts |
| solution (anionic low-molecular | | |
| weight surfactant) | | |
| Ion-exchanged water | 55.0 | parts |

### Comparative Example 6

An aqueous ink for inkjet recording was prepared and evaluated in the same manner as in Comparative Example 4 except that in preparation of the dispersion H4 of carbon black particles (pigment dispersion) in Comparative Example 4, the composition of the pigment dispersion was changed as follows.

(Composition of Dispersion H6 of Carbon Black Particles)

| | | |
|---|---|---|
| Carbon black | 10.0 | parts |
| (trade name: NIPEX 180-IQ, manufactured | | |
| by Degussa) | | |
| 1% sodium 2-ethylhexylsulfosuccinate | 25.0 | parts |
| aqueous solution (anionic low-molecular | | |
| weight surfactant) | | |
| Ion-exchanged water | 55.0 | parts |

### Comparative Example 7

An aqueous ink for inkjet recording was prepared and evaluated in the same manner as in Comparative Example 4 except that in preparation of the dispersion H4 of carbon black particles (pigment dispersion) in Comparative Example 4, the composition of the pigment dispersion was changed as follows.

(Composition of Dispersion H7 of Resin-Coated Carbon Black Particles)

| | | |
|---|---|---|
| Carbon black | 10.0 | parts |
| (trade name: NIPEX 180-IQ, manufactured | | |
| by Degussa) | | |
| 1% sodium dodecylbenzenesulfonate | 40.0 | parts |
| aqueous solution (anionic low-molecular | | |
| weight surfactant) | | |
| Ion-exchanged water | 50.0 | parts |

TABLE 1

| | | | | | Anionic | | | | | |
|---|---|---|---|---|---|---|---|---|---|---|
| | Water-Insoluble Resins | | | | Low-Molecular | | | | | |
| | | Weight- | | Water- | Weight Surfactants | | Pigment | Pigment | | |
| | | average | Acid | insoluble | | Surfactant/ | dispersion | dispersion | | |
| | | molecular | value (mg | resin/carbon | | carbon | particle | filtering | Discharge | Abrasion |
| | Type | weight | KOH/g) | black (%) | Type | black (%) | size (nm) | property | stability | resistance |
| Example 1 | P-1: Phenoxyethyl | 43500 | 65.2 | 45 | Sodium | 10 | 91 | AA | A | A |
| | methacrylate/methyl | | | | oleate | | | | | |
| | methacrylate/methacrylic | | | | | | | | | |
| | acid/(70/20/10) | | | | | | | | | |
| Example 2 | P-2: Phenoxyethyl | 48200 | 71.7 | 45 | Sodium | 10 | 94 | AA | A | A |
| | methacrylate/ethyl | | | | oleate | | | | | |
| | methacrylate/methacrylic | | | | | | | | | |
| | acid (50/39/11) | | | | | | | | | |
| Example 3 | P-3 Phenoxyethyl | 38900 | 65.2 | 45 | Sodium | 10 | 87 | AA | A | A |
| | methacrylate/ethyl | | | | oleate | | | | | |
| | acrylate/acrylic acid | | | | | | | | | |
| | (45/45/10) | | | | | | | | | |
| Example 4 | P-1: Phenoxyethyl | 43500 | 65.2 | 20 | Sodium | 1 | 105 | AA | A | B |
| | methacrylate/methyl | | | | oleate | | | | | |
| | methacrylate/methacrylic | | | | | | | | | |
| | acid // (70/20/10) | | | | | | | | | |
| Example 5 | P-1: Phenoxyethyl | 43500 | 65.2 | 60 | Sodium | 1 | 99 | AA | A | AA |
| | methacrylate/methyl | | | | oleate | | | | | |
| | methacrylate/methacrylic | | | | | | | | | |
| | acid // (70/20/10) | | | | | | | | | |
| Example 6 | P-1: Phenoxyethyl | 43500 | 65.5 | 45 | Sodium | 0.01 | 118 | A | A | A |
| | methacrylate/methyl | | | | oleate | | | | | |
| | methacrylate/methacrylic | | | | | | | | | |
| | acid // (70/20/10) | | | | | | | | | |
| Example 7 | P-1: Phenoxyethyl | 43500 | 65.2 | 45 | Sodium | 20 | 85 | A | A | A |
| | methacrylate/methyl | | | | oleate | | | | | |
| | methacrylate/methacrylic | | | | | | | | | |
| | acid // (70/20/10) | | | | | | | | | |
| Example 8 | P-2: Phenoxyethyl | 48200 | 71.7 | 45 | Oleoyl- | 0.05 | 95 | A | A | A |
| | methacrylate/ethyl | | | | methyl- | | | | | |
| | methacrylate/methacrylic | | | | taurine | | | | | |
| | acid (50/39/11) | | | | sodium | | | | | |
| Example 9 | P-2: Phenoxyethyl | 48200 | 71.7 | 45 | Sodium | 0.05 | 98 | A | A | A |
| | methacrylate/ethyl | | | | 2-ethyl- | | | | | |
| | methacrylate/methacrylic | | | | hexylsulfo | | | | | |
| | acid (50/39/11) | | | | succinate | | | | | |
| Example 10 | P-2: Phenoxyethyl | 48200 | 71.7 | 45 | Sodium | 0.05 | 98 | A | A | A |
| | methacrylate/ethyl | | | | dodecyl- | | | | | |
| | methacrylate/methacrylic | | | | benzene | | | | | |
| | acid (50/39/11) | | | | sulfonate | | | | | |
| Comparative | P-1: Phenoxyethyl | 43500 | 65.2 | 45 | — | — | 115 | B | B | A |
| Example 1 | methacrylate/methyl | | | | | | | | | |
| | methacrylate/methacrylic | | | | | | | | | |
| | acid // (70/20/10) | | | | | | | | | |
| Comparative | P-2: Phenoxyethyl | 48200 | 71.7 | 45 | — | — | 119 | C | B | A |
| Example 2 | methacrylate/ | | | | | | | | | |
| | ethyl methacrylate/ | | | | | | | | | |
| | methacrylic acid | | | | | | | | | |
| | (50/39/11) | | | | | | | | | |
| Comparative | P-3 Phenoxyethyl | 38900 | 65.2 | 45 | — | — | 98 | B | B | A |
| Example 3 | methacrylate/ethyl | | | | | | | | | |
| | acrylate/acrylic acid | | | | | | | | | |
| | (45/45/10) | | | | | | | | | |
| Comparative | — | — | — | — | Sodium | 20 | 89 | B | B | C |
| Example 4 | | | | | oleate | | | | | |
| Comparative | — | — | — | — | Oleoyl- | 5 | 79 | C | B | C |
| Example 5 | | | | | methyl- | | | | | |
| | | | | | taurine | | | | | |
| | | | | | sodium | | | | | |
| Comparative | — | — | — | — | Sodium | 5 | 81 | C | B | C |
| Example 6 | | | | | 2-ethyl- | | | | | |
| | | | | | hexylsulfo | | | | | |
| | | | | | succinate | | | | | |
| Comparative | — | — | — | — | Sodium | 20 | 108 | B | B | C |
| Example 7 | | | | | dodecyl- | | | | | |
| | | | | | benzene | | | | | |
| | | | | | sulfonate | | | | | |

As can be seen from Table 1, the pigment dispersions manufactured by the method for manufacturing a pigment dispersion according to the invention are excellent in filtering property. It can also be seen that the aqueous inks for inkjet recording in the invention are excellent in discharge stability.

According to the present invention, it is possible to provide a method for manufacturing a pigment dispersion that has favorable dispersion stability, an aqueous ink for inkjet recording that is excellent in discharge stability, and a method for manufacturing the aqueous ink for inkjet recording.

Hereinafter exemplary embodiments of the present invention will be listed. However, the present invention is not limited to the following exemplary embodiments.
<1> A method for manufacturing a pigment dispersion, the method comprising:

mixing a water-insoluble resin, carbon black, a neutralizing agent, an organic solvent, an anionic low-molecular weight surfactant and an aqueous medium to form an aqueous dispersion; and

removing at least a part of the organic solvent from the aqueous dispersion.
<2> The method for manufacturing a pigment dispersion of <1>, wherein the water-insoluble resin comprises a structural unit represented by the following formula (I).

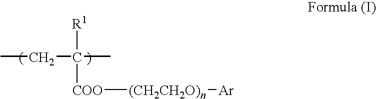

In formula (I), R¹ represents a hydrogen atom or a methyl group, Ar represents an unsubstituted or substituted aromatic ring, and n represents an average repeating number from 1 to 6.
<3> The method for manufacturing a pigment dispersion of <2>, wherein, in formula (I) the aromatic ring represented by Ar is an unsubstituted or substituted benzene ring.
<4>The method for manufacturing a pigment dispersion of <2>, wherein

the water-insoluble resin comprises a hydrophilic structural unit derived from acrylic acid or methacrylic acid and a hydrophobic structural unit represented by formula (I);

the content of aromatic rings in the water-insoluble resin is 20% by mass or less with respect to the total mass of the water-insoluble resin; and

the total content of the total hydrophilic structural units in the water-insoluble resin is 15% by mass or less with respect to the total mass of the water-insoluble resin.
<5> The method for manufacturing a pigment dispersion of <1>, wherein the acid value of the water-insoluble resin is from 30 mgKOH/g to 100 mgKOH/g.
<6> The method for manufacturing a pigment dispersion of <1>, wherein, in the aqueous dispersion, the content of the anionic low-molecular surfactant with respect to the content of the carbon black is from 0.01% by mass to 10% by mass.
<7> A method for manufacturing an aqueous ink for inkjet recording, the method comprising:

mixing a water-insoluble resin, carbon black, a neutralizing agent, an organic solvent, an anionic low-molecular weight surfactant and an aqueous medium to form an aqueous dispersion;

removing at least a part of the organic solvent from the aqueous dispersion to form a pigment dispersion; and

preparing an aqueous ink for inkjet recording using the pigment dispersion.
<8> The method for manufacturing an aqueous ink for inkjet recording of <7>, wherein the water-insoluble resin comprises a structural unit represented by the following formula (I).

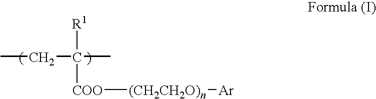

In formula (I), R¹ represents a hydrogen atom or a methyl group, Ar represents an unsubstituted or substituted aromatic ring, and n represents an average repeating number from 1 to 6.
<9> The method for manufacturing an aqueous ink for inkjet recording of <8>, wherein, in formula (I), the aromatic ring represented by Ar is an unsubstituted or substituted benzene ring.
<10> The method for manufacturing an aqueous ink for inkjet recording of <8>, wherein

the water-insoluble resin comprises a hydrophilic structural unit derived from acrylic acid or methacrylic acid and a hydrophobic structural unit represented by formula (I),

the content of aromatic rings in the water-insoluble resin is 20% by mass or less with respect to the total mass of the water-insoluble resin, and

the total content of the hydrophilic structural units in the water-insoluble resin is 15% by mass or less with respect to the total mass of the water-insoluble resin.
<11> The method for manufacturing an aqueous ink for inkjet recording of <7>, wherein the acid value of the water-insoluble resin is from 30 mgKOH/g to 100 mgKOH/g.
<12> The method for manufacturing an aqueous ink for inkjet recording of <7>, wherein, in the aqueous dispersion, the content of the anionic low-molecular surfactant with respect to the content of the carbon black is from 0.01% by mass to 10% by mass.
<13> An aqueous ink for inkjet recording, which is manufactured by the method for manufacturing a pigment dispersion of <1>.

All publications, patent applications, and technical standards mentioned in this specification are herein incorporated by reference to the same extent as if each individual publication, patent application, or technical standard was specifically and individually indicated to be incorporated by reference.

What is claimed is:

1. A method for manufacturing a pigment dispersion, the method comprising:
mixing a water-insoluble resin, carbon black, a neutralizing agent, an organic solvent, an anionic low-molecular weight surfactant and an aqueous medium to form an aqueous dispersion; and
removing at least a part of the organic solvent from the aqueous dispersion.

2. The method for manufacturing a pigment dispersion of claim 1, wherein the water-insoluble resin comprises a structural unit represented by the following formula (I): 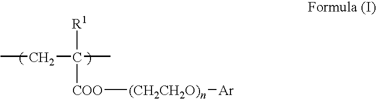
wherein, in formula (I), R¹ represents a hydrogen atom or a methyl group, Ar represents an unsubstituted or substituted aromatic ring, and n represents an average repeating number from 1 to 6.

3. The method for manufacturing a pigment dispersion of claim 2, wherein, in formula (I), the aromatic ring represented by Ar is an unsubstituted or substituted benzene ring.

4. The method for manufacturing a pigment dispersion of claim 2, wherein:
the water-insoluble resin comprises a hydrophilic structural unit derived from acrylic acid or methacrylic acid, and a hydrophobic structural unit represented by formula (I);
the content of aromatic rings in the water-insoluble resin is 20% by mass or less with respect to the total mass of the water-insoluble resin; and
the total content of the hydrophilic structural units in the water-insoluble resin is 15% by mass or less with respect to the total mass of the water-insoluble resin.

5. The method for manufacturing a pigment dispersion of claim 1, wherein the acid value of the water-insoluble resin is from 30 mgKOH/g to 100 mgKOH/g.

6. The method for manufacturing a pigment dispersion of claim 1, wherein, in the aqueous dispersion, the content of the anionic low-molecular surfactant with respect to the content of the carbon black is from 0.01% by mass to 10% by mass.

7. A method for manufacturing an aqueous ink for inkjet recording, the method comprising:
mixing a water-insoluble resin, carbon black, a neutralizing agent, an organic solvent, an anionic low-molecular weight surfactant and an aqueous medium to form an aqueous dispersion;
removing at least a part of the organic solvent from the aqueous dispersion to form a pigment dispersion; and
preparing an aqueous ink for inkjet recording using the pigment dispersion.

8. The method for manufacturing an aqueous ink for inkjet recording of claim 7, wherein the water-insoluble resin comprises a structural unit represented by the following formula (I): 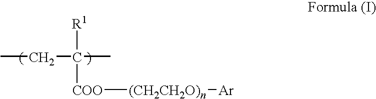
wherein, in formula (I), R¹ represents a hydrogen atom or a methyl group, Ar represents an unsubstituted or substituted aromatic ring, and n represents an average repeating number from 1 to 6.

9. The method for manufacturing an aqueous ink for inkjet recording of claim 8, wherein, in formula (I), the aromatic ring represented by Ar is an unsubstituted or substituted benzene ring.

10. The method for manufacturing an aqueous ink for inkjet recording of claim 8, wherein:
the water-insoluble resin comprises a hydrophilic structural unit derived from acrylic acid or methacrylic acid, and a hydrophobic structural unit represented by formula (I);
the content of aromatic rings in the water-insoluble resin is 20% by mass or less with respect to the total mass of the water-insoluble resin; and
the total content of the hydrophilic structural units in the water-insoluble resin is 15% by mass or less with respect to the total mass of the water-insoluble resin.

11. The method for manufacturing an aqueous ink for inkjet recording of claim 7, wherein the acid value of the water-insoluble resin is from 30 mgKOH/g to 100 mgKOH/g.

12. The method for manufacturing an aqueous ink for inkjet recording of claim 7, wherein, in the aqueous dispersion, the content of the anionic low-molecular surfactant with respect to the content of the carbon black is from 0.01% by mass to 10% by mass.

13. An aqueous ink for inkjet recording, which is manufactured by the method for manufacturing a pigment dispersion of claim 1.
